(19) United States
(12) Patent Application Publication
(10) Pub. No.: US 2023/0267430 A1
(43) Pub. Date: Aug. 24, 2023

(54) DATA PROCESSING METHOD AND DEVICE, AND COMPUTER-READABLE STORAGE MEDIUM

(71) Applicant: Tencent Cloud Computing (Beijing) Co., Ltd., Beijing (CN)

(72) Inventors: Yan ZHANG, Beijing (CN); Haifeng DING, beijing (CN)

(73) Assignee: Tencent Cloud Computing (Beijing) Co., Ltd., Beijing (CN)

(21) Appl. No.: 18/121,703

(22) Filed: Mar. 15, 2023

Related U.S. Application Data
(63) Continuation of application No. PCT/CN2021/108480, filed on Jul. 26, 2021.

(30) Foreign Application Priority Data
May 19, 2021 (CN) 2021105477727

(51) Int. Cl. G06Q 20/10; G06Q 20/40

(52) U.S. Cl. CPC G06Q 20/102; G06Q 20/401

(57) ABSTRACT

The present disclose relates to a data processing method and device. The method includes: acquiring a transaction request for a target article, and invoking a universal transaction component according to the transaction request, the universal transaction component being integrated with a universal transaction function corresponding to M transaction manners, the transaction request carrying an article metric value and a target transaction manner for the target article; performing, with the universal transaction component, article metric transfer processing of the article metric value according to first article data of the target article and the target transaction manner, to acquire an article metric transfer credential for the target article; sending, with the universal transaction component, the article metric transfer credential to a universal component server; and sending, with the universal transaction component, an article transfer request generated according to the credential verification result to the universal component server.

### RELATED APPLICATION

This application is a continuation application of PCT Patent Application No. PCT/CN2021/108480, filed on Jul. 26, 2021, which claims priority to Chinese Patent Application No. 202110547772.7, entitled “DATA PROCESSING METHOD AND DEVICE, AND COMPUTER-READABLE STORAGE MEDIUM” filed on May 19, 2021, wherein the content of the above-referenced applications is incorporated herein by reference in its entirety.

### FIELD OF THE TECHNOLOGY

This disclosure relates to the field of Internet technologies, and in particular, to a data processing method and device, and a computer-readable storage medium.

### BACKGROUND OF THE DISCLOSURE

With increasing improvement of Internet technologies and social progress, mobile payment is rapidly popularized.

There are many payment manners and payment platforms for implementing mobile payment. However, payment platforms are independent, and payment manners supported by different payment platforms are also independent. For example, payment platform A supports payment manner 1 (which may be understood as transaction manner 1), payment platform B supports payment manner 2, and payment manner 3. If an application developer integrates only payment manner 1 supported by payment platform A into an application client developed by the application developer, when a user uses the application client, an article can be traded in payment manner 1 only, but article cannot be traded in payment manners 2 and 3 supported by payment platform B.

To facilitate the user to purchase an article by using multiple payment manners in the application client, the application developer needs to integrate the multiple payment manners into the application client. In a related technology, to access multiple payment manners, such as payment manner 1 and payment manner 3, an application side needs to perform access processing on payment manner 1, and needs to perform a large quantity of adaptation work, where access processing and adaptation processing require a large amount of time and manpower. Specific access work and adaptation work for payment manner 3 are different from access work and adaptation work for payment manner 1. Therefore, a method for integrating a payment manner or a payment function has an inefficient defect.

### SUMMARY

Embodiments of this disclosure provide a data processing method and device, and a computer-readable storage medium, which can improve efficiency of integrating multiple payment manners into an application client.

An aspect of the embodiments of this disclosure provides a data processing method, performed by a computer device and including:
acquiring a transaction request for a target article, and invoking a universal transaction component according to the transaction request, the universal transaction component being integrated with a universal transaction function corresponding to M transaction manners, the universal transaction component being integrated into a target application client, the transaction request carrying an article metric value for the target article and a target transaction manner for the target article, M being a positive integer, and the M transaction manners comprising the target transaction manner;
performing, with the universal transaction component, article metric transfer processing of the article metric value according to first article data of the target article and the target transaction manner, to acquire an article metric transfer credential for the target article;
sending, with the universal transaction component, the article metric transfer credential to a universal component server, so that the universal component server returns a credential verification result, the universal component server being a server associated with the universal transaction component; and
sending, with the universal transaction component, an article transfer request generated according to the credential verification result to the universal component server, so that the universal component server returns article transfer feedback information for the target article.

An aspect of the embodiments of this disclosure provides a data processing method, performed by a computer device and including:
acquiring an article configuration request for a target application client, the target application client being integrated with a universal transaction component, the universal transaction component being integrated with a universal transaction function corresponding to M transaction manners, M being a positive integer, the M transaction manners comprising a target transaction manner, and an article in the target application client comprising a target article;
invoking an article configuration component according to the article configuration request, and configuring the article in the target application client using the article configuration component, to generate article configuration information, the article configuration component being provided by a universal component server, the universal component server being a server associated with the universal transaction component, and the article configuration information comprising first article data corresponding to the target article; and
acquiring a configuration pull request that is sent by a user terminal and that is for the target application client, and sending the article configuration information to the user terminal according to the configuration pull request, so that the user terminal invokes the universal transaction component in response to obtaining a transaction request for the target article, and performs article transaction processing on the target article according to the first article data and the target transaction manner carried in the transaction request, the user terminal referring to a terminal on which the target application client is installed.

An aspect of the embodiments of this disclosure provides a data processing apparatus, including a memory operable to store computer-readable instructions and a processor circuitry operable to read the computer-readable instructions. When executing the computer-readable instructions, the processor circuitry is configured to:
acquire a transaction request for a target article, and invoke a universal transaction component according to the transaction request, the universal transaction component being integrated with a universal transaction function corresponding to M transaction manners, the universal transaction component being integrated into a target application client, the transaction request carrying an article metric value for the target article and a target transaction manner for the target article, M being a positive integer, and the M transaction manners comprising the target transaction manner;
perform, with the universal transaction component, article metric transfer processing of the article metric value according to first article data of the target article and the target transaction manner, to acquire an article metric transfer credential for the target article;
send, with the universal transaction component, the article metric transfer credential to a universal component server, so that the universal component server returns a credential verification result, the universal component server being a server associated with the universal transaction component; and
send, with the universal transaction component, an article transfer request generated according to the credential verification result to the universal component server, so that the universal component server returns article transfer feedback information for the target article.

An aspect of the embodiments of this disclosure provides a computer-readable storage medium. The computer-readable storage medium stores a computer program. The computer program is adapted to be loaded and executed by a processor, to perform the method in the embodiment of this disclosure.

An aspect of the embodiments of this disclosure provides a computer program product or a computer program. The computer program product or the computer program includes computer instructions, and the computer instructions are stored in a computer readable storage medium. A processor of a computer device reads the computer instructions from the computer readable storage medium, and the processor executes the computer instructions, so that the computer device performs the method in the embodiment of this disclosure.

In the embodiments of this disclosure, the universal transaction component is integrated with a universal transaction function corresponding to multiple transaction manners. Therefore, by integrating the universal transaction component into the target application client, not only the article in the target application client can be purchased by a user in multiple payment manners (that is, the foregoing M transaction manners), but also access efficiency of the application developer integrating multiple payment manners into the target application client can be improved. In addition, in the embodiments of this disclosure, both the article metric transfer credential such as the asset transfer credential and the credential verification result can be sent to the universal component server by using the universal transaction component, so that the universal component server performs a corresponding operation and returns a result (including the foregoing credential verification result and article transfer feedback information). In a user payment process, verification processing on a transaction request that is only concentrated on the target application server (a background server corresponding to the target application client) can be avoided, and payment efficiency and accuracy of the user can be improved. Because the universal component server may undertake some verification processing workload for the target application server, the target application server may save computing resources to process other user requests received from the target application client, thereby improving the application processing performance of the target application server.

### BRIEF DESCRIPTION OF THE DRAWINGS

FIG. 1 is a schematic diagram of a system architecture according to an embodiment of this disclosure.

FIG. 2 is a schematic diagram of a technical framework of a transaction system that integrates multiple transaction manners according to an embodiment of this disclosure.

FIG. 3 is a schematic flowchart of a data processing method according to an embodiment of this disclosure.

FIG. 4 is a schematic diagram of a data processing scenario according to an embodiment of this disclosure.

FIG. 5 is a schematic diagram of a data processing scenario according to an embodiment of this disclosure.

FIG. 6 is a schematic diagram of a data processing scenario according to an embodiment of this disclosure.

FIG. 7 is a schematic diagram of a data processing scenario according to an embodiment of this disclosure.

FIG. 8 is a schematic diagram of a data processing scenario according to an embodiment of this disclosure.

FIG. 9 is a schematic diagram of a data processing scenario according to an embodiment of this disclosure.

FIG. 10 is a schematic diagram of a data processing scenario according to an embodiment of this disclosure.

FIG. 11 is a schematic flowchart of a data processing method according to an embodiment of this disclosure.

FIG. 12 is a schematic flowchart of a data processing method according to an embodiment of this disclosure.

FIG. 13 is a schematic architecture diagram of an article configuration according to an embodiment of this disclosure.

FIG. 14 is a schematic diagram of a data processing scenario according to an embodiment of this disclosure.

FIG. 15 is a schematic diagram of data flow between multiple platforms according to an embodiment of this disclosure.

FIG. 16 is a basic framework diagram of an AB test according to an embodiment of this disclosure.

FIG. 17 is a schematic diagram of a data processing scenario according to an embodiment of this disclosure.

FIG. 18 is a schematic structural diagram of a data processing apparatus according to an embodiment of this disclosure.

FIG. 19 is a schematic structural diagram of a data processing apparatus according to an embodiment of this disclosure.

FIG. 20 is a schematic structural diagram of a computer device according to an embodiment of this disclosure.

FIG. 21 is a schematic structural diagram of a computer device according to an embodiment of this disclosure.

### DESCRIPTION OF EMBODIMENTS

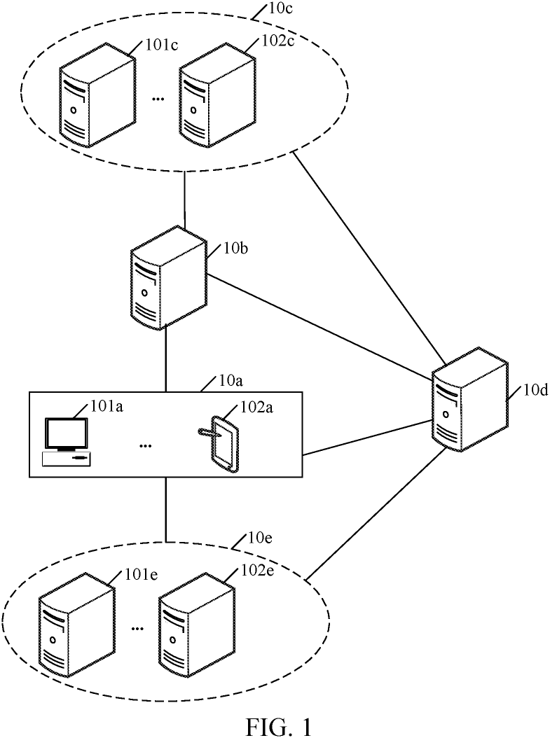

FIG. 1 is a schematic diagram of a system architecture according to an embodiment of this disclosure. The system may include a public server 10b, a universal component server 10d, a user terminal cluster 10a, an application server cluster 10c, and a transaction server cluster 10e. The application server cluster 10c may include: an application server 101c, ..., and an application server 102c. It may be understood that the foregoing system may include one or more application servers, and a quantity of application servers is not limited herein. Each application server in the application server cluster 10c may be a background server corresponding to an application that has an article transaction function. For example, the application server 101c is a background server corresponding to an application 1, and the application server 102c is a background server corresponding to an application 2. The foregoing mentioned application may be an application such as a social application, a multimedia application (for example, a video application), an entertainment application (for example, a game application), an education application, or a live streaming application. The application may be an independent application, or may be an embedded sub-application integrated in an application (for example, a social application, an education application, or a multimedia application), which is not limited herein. An article in the application may be a virtual article, or may be a physical article, which is not limited herein.

The universal component server 10d may provide a universal transaction component for each application server in the application server cluster 10c, the universal transaction component may have a universal transaction function jointly corresponding to M transaction manners, M is a positive integer, and M may be less than or equal to a total quantity of transaction servers in the transaction server cluster 10e. For example, the universal component server 10d provides a universal transaction component for the application server 101c, and the application server 101c may integrate the universal transaction component into an application data packet corresponding to the application 1. By embedding the universal transaction component into the application data packet corresponding to the application 1, when the application server 101c accesses M transaction manners, each transaction server in the transaction server cluster 10e may be prevented from being directly interconnected to the transaction function. It may be understood that the universal component server 10d is interconnected to the transaction server in advance, and integrates a transaction manner corresponding to each transaction server into the universal transaction component, and then provides the universal transaction component integrated with the M transaction manners to the application server in the application server cluster 10c.

In addition, the universal component server 10d may provide an article configuration component for each application server in the application server cluster 10c. The article configuration component may have a universal configuration function jointly corresponding to W configuration manners, and W is a positive integer. For example, the universal component server 10d provides an article configuration component for the application server 101c. By using the article configuration component, the application server 101c may separately configure N articles included in the application 1 to obtain article configuration information that includes the N articles, where N is a positive integer. Subsequently, the application server 101c may send the article configuration information to the public server 10b, so that the application server 101c stores the article configuration information for the application 1.

In addition, the universal component server 10d may provide the foregoing article configuration component for the public server 10b. In this case, after obtaining an article corresponding to each application server, the public server 10b may locally perform article configuration for the article corresponding to each application server. For example, if the public server 10b obtains the N articles that are sent by the application server 101c and that are for the application 1, and obtains the article configuration component provided by the universal component server 10d, the public server 10b may locally separately configure the N articles for the application 1 to obtain the article configuration information for the application 1. It may be understood that the foregoing system may include one or more universal component servers, and a quantity of universal component servers is not limited herein.

The public server 10b may store article configuration information corresponding to each application server. For example, the public server 10b may store article configuration information corresponding to the application server 101c, and may store article configuration information corresponding to the application server 102c. The foregoing mentioned article configuration information may be sent to the public server 10b after the corresponding application server locally configures the article, or may be obtained after the public server 10b locally configures the article corresponding to each application, which is not limited in this embodiment of this disclosure. It may be understood that the foregoing system may include one or more public servers, and a quantity of the public servers is not limited herein.

As shown in FIG. 1, the transaction server cluster 10e may include: a transaction server 101e, ..., and a transaction server 102e. It may be understood that the foregoing system may include one or more transaction servers, and a quantity of transaction servers is not limited herein. Each transaction server in the transaction server cluster 10e may be a background server corresponding to an application that has an asset transfer function (equivalent to a transaction payment function). For example, the transaction server 101e is a background server corresponding to an application 3 that has a transaction payment function, and the transaction server 102e is a background server corresponding to an application 4 that has a transaction payment function. It may be understood that the application 3 may be equivalent to the foregoing mentioned application 1, that is, an application exists, which can implement both an article transaction function and a transaction payment function.

As shown in FIG. 1, the user terminal cluster 10a may include: a user terminal 101a, ..., and a user terminal 102a. It may be understood that the foregoing system may include one or more user terminals, and a quantity of the user terminals is not limited herein. The foregoing application may be installed on each user terminal in the user terminal cluster 10a. That is, the user terminal cluster 10a may include an application client corresponding to the foregoing application. For example, the user terminal 101a may be installed with the application 1, the application 2, the application 3, and the application 4, and the user terminal 102a may be installed with the application 1 and the application 3.

A communication connection may exist between the user terminal cluster 10a, for example, a communication connection exists between the user terminal 101a and the user terminal 102a. In addition, any user terminal in the user terminal cluster 10a may have a communication connection to the public server 10b. For example, there is a communication connection between the user terminal 101a and the public server 10b, and there is a communication connection between the user terminal 102a and the public server 10b. Any user terminal in the user terminal cluster 10a may have a communication connection to the universal component server 10d. For example, there is a communication connection between the user terminal 101a and the universal component server 10d, and there is a communication connection between the user terminal 102a and the universal component server 10d. Any user terminal in the user terminal cluster 10a may have a communication connection to any application server in the application server cluster 10c. For example, there is a communication connection between the user terminal 101a and the application server 101c, and there is a communication connection between the user terminal 102a and the application server 101c. Any user terminal in the user terminal cluster 10a may have a communication connection to any transaction server in the transaction server cluster 10e. For example, there is a communication connection between the user terminal 101a and the transaction server 101e, and there is a communication connection between the user terminal 102a and the transaction server 102e.

The public server 10b may have a communication connection to the universal component server 10d. The public server 10b may have a communication connection to any application server in the application server cluster 10c. For example, there is a communication connection between the public server 10b and the application server 101c, and there is a communication connection between the public server 10b and the application server 102c. The public server 10b may have a communication connection to any transaction server in the transaction server cluster 10e, for example, there is a communication connection between the public server 10b and the transaction server 101e, and there is a communication connection between the public server 10b and the transaction server 102e.

A communication connection may exist between the application server cluster 10c, for example, a communication connection exists between the application server 101c and the application server 102c. Any application server in the application server cluster 10c may have a communication connection to the universal component server 10d. For example, there is a communication connection between the application server 101c and the public server 10b, and there is a communication connection between the application server 102c and the public server 10b. Any application server in the application server cluster 10c may have a communication connection to any transaction server in the transaction server cluster 10e. For example, there is a communication connection between the application server 101c and the transaction server 101e, and there is a communication connection between the application server 101c and the transaction server 102e.

A communication connection may exist between the transaction server cluster 10e, for example, a communication connection exists between the transaction server 101e and the transaction server 102e. Any transaction server in the transaction server cluster 10e may have a communication connection to the universal component server 10d. For example, there is a communication connection between the transaction server 101e and the public server 10b, and there is a communication connection between the transaction server 102e and the public server 10b.

The foregoing communication connection manner is not limited, and the connection may be directly or indirectly connected in a wired communication manner, or may be directly or indirectly connected in a wireless communication manner, or may be in another manner, which is not limited in this application.

It may be understood that the public server 10b, the universal component server 10d, the user terminal 101a, ..., the user terminal 102a, the application server 101c, ..., the application server 102c, the transaction server 101e, ..., and the transaction server 102e may all be blockchain nodes in a blockchain network. Data (for example, article configuration information) described in the following may be stored in a manner in which the blockchain node generates a block according to the data, and adds the block to a blockchain for storage.

A blockchain is a new application mode of a computer technology such as distributed data storage, point-to-point transmission, a consensus mechanism, or an encryption algorithm. It is mainly used for sorting data in chronological order and encrypting the data into a ledger, so that the data cannot be tampered with or forged, and the data can be verified, stored, and updated. The blockchain is essentially a decentralized database, and each node in the database stores the same blockchain. The blockchain network may divide blockchain nodes into a core node, a data node, and a light node. The core node is responsible for consensus of the blockchain in the whole network, that is, the core node is a consensus node in the blockchain network. A process in which transaction data in a blockchain network is written into a ledger may be as follows: A data node or a light node in the blockchain network obtains transaction data, and transmits the transaction data in the blockchain network (that is, the node transmits the transaction data in a relay manner) until a consensus node receives the transaction data, and the consensus node encapsulates the transaction data into a block, performs execution consensus, and writes the transaction data into the ledger after the consensus is completed. In this case, article configuration information is used as an example of the transaction data, and the public server 10b (which is equivalent to the consensus node) generates a block according to the transaction data after consensus is performed on the transaction data and stores the block in the blockchain network. For reading of the transaction data (that is, the article configuration information), the blockchain node may obtain, in the blockchain network, a block including the transaction data, and further acquire the transaction data from the block.

In FIG. 1, the public server 10b, the universal component server 10d, the user terminal 101a, ..., the user terminal 102a, the application server 101c, ..., the application server 102c, the transaction server 101e, ..., and the transaction server 102e may include a mobile phone, a tablet computer, a notebook computer, a palmtop computer, a smart speaker, a mobile Internet device (MID), a point of sales (POS) machine, a wearable device (such as a smart watch or a smart band), and the like.

It may be understood that the data processing method provided in this embodiment of this disclosure may be performed by a computer device, and the computer device includes but is not limited to a user terminal or a server (including the public server, the universal component server, the application server, and the transaction server that are shown in FIG. 1). The server may be an independent physical server, or may be a server cluster or a distributed system formed by multiple physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The user terminal may be a smartphone, a tablet computer, a notebook computer, a desktop computer, a smart speaker, a smartwatch, or the like, but is not limited thereto. The user terminal and the server may be directly or indirectly connected in a wired or wireless communication manner, which is not limited in this application.

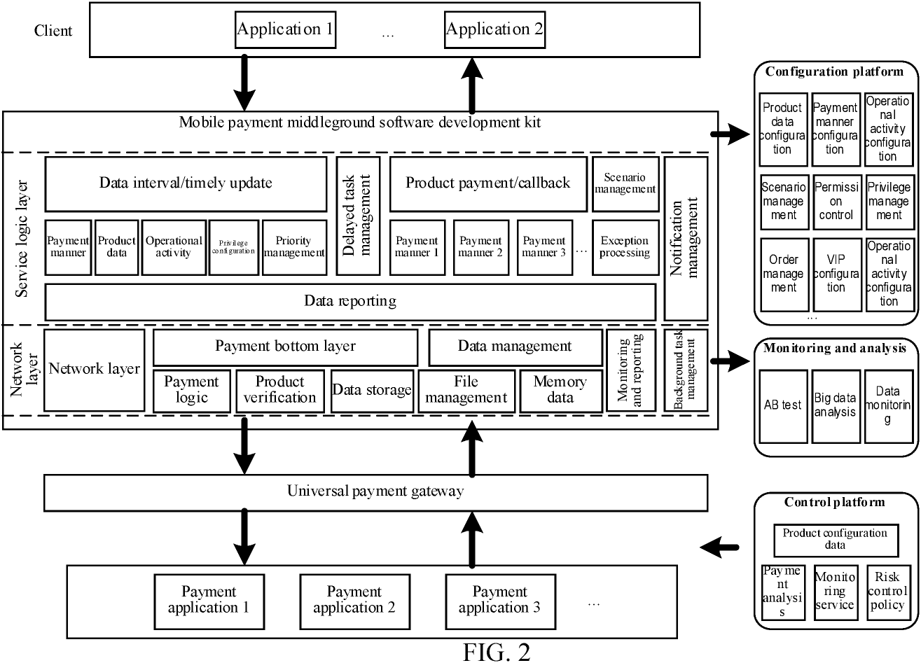

Further, FIG. 2 is a schematic diagram of a technical framework of a transaction system that integrates multiple transaction manners according to an embodiment of this disclosure. As shown in FIG. 2, the technical framework may include a software development kit (SDK), a configuration platform, a monitoring and analysis platform, a universal payment gateway, and a control platform. Roles and functions of each part are described below.

1. Mobile payment middle ground SDK: The part may be divided into a service logic layer and a network layer. The service logic layer is mainly responsible for data update, product payment (equivalent to article transaction payment), scenario management, exception processing, and notification management. Data update may include payment methods (equivalent to transaction methods), product data (equivalent to article data), operational activities, privilege configuration, and priority management. Product payment may include multiple transaction manners, for example, the payment manner 1, the payment manner 2, ..., and the payment manner 3: The payment manner 1 may be supported by the payment application 1 (the background server corresponding to the payment application 1 in FIG. 2 is the transaction server 1), the payment manner 2 may be supported by the payment application 2 (the background server corresponding to the payment application 2 in FIG. 2 is the transaction server 2), and the payment manner 3 may be supported by the payment application 3 (the background server corresponding to the payment application 3 in FIG. 2 is the transaction server 3).

The network layer is mainly responsible for data management, monitoring and background task management at the bottom layer, provides a corresponding payment callback function and service data reporting function, and triggers the payment function at the bottom layer. The payment layer may include payment logic, product verification, and data storage.

The mobile payment middle ground SDK is integrated into the application client on the application side. In the application 1 and the application 2 shown in FIG. 2, the application client is installed in the user terminal, for example, the user terminal may install the application 1 and the application 2.

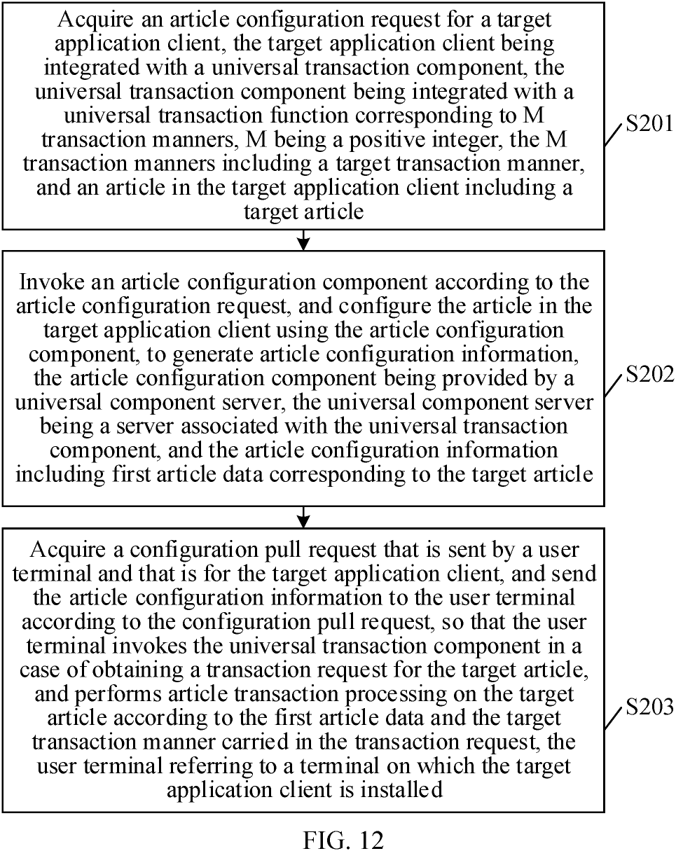

2. Configuration platform: This part is mainly used for configuring various functions, including product data configuration, payment mode configuration, operational activity configuration, scenario management, order management, right control privilege management, member configuration, and operational activity configuration. The configuration platform may include the public server 10b in FIG. 1, may also include the application server in the application server cluster 10c in FIG. 1, and may further include the public server 10b and the application server. A range of the configuration platform is not limited herein, and may be set according to an actual application scenario. For a specific configuration process, refer to the following embodiment corresponding to FIG. 12.

3. Monitoring and analysis platform The monitoring and analysis platform may include the public server 10b shown in FIG. 1. This part is responsible for monitoring important data content in a payment process, and includes an AB test function, a big data analysis function, and a property plus (PP) data monitoring function. The AB Test is mainly responsible for performing a AB-Test experiment according to a guest range of a user, and determining an effect of a function according to experimental data. Big data analysis mainly analyzes abnormal payment and successful clustering, and provides available data at any time. PP data monitoring is mainly responsible for statistics and monitoring of server interfaces, and provides alarm functions and prompts when the server interfaces are abnormal.

4. Control platform: The platform may include the universal component server 10d shown in FIG. 1. This part is mainly responsible for configuration and registration of a product (equivalent to an article), payment monitoring service of a user, a payment risk control policy, and payment analysis of a user. In addition, statistics about a payment success rate and a failure rate of each product are provided, and a corresponding alarm service may be provided according to a configured alarm policy.

For many applications, how to quickly and efficiently access the payment function is particularly important. Especially for newly-established services, the quick access payment function is more important in a situation where human resources are in shortage. In this embodiment of this disclosure, a method for implementing a multi-payment manner based on a universal transaction component and an article configuration component is proposed for a problem about how to quickly and efficiently access a payment function.

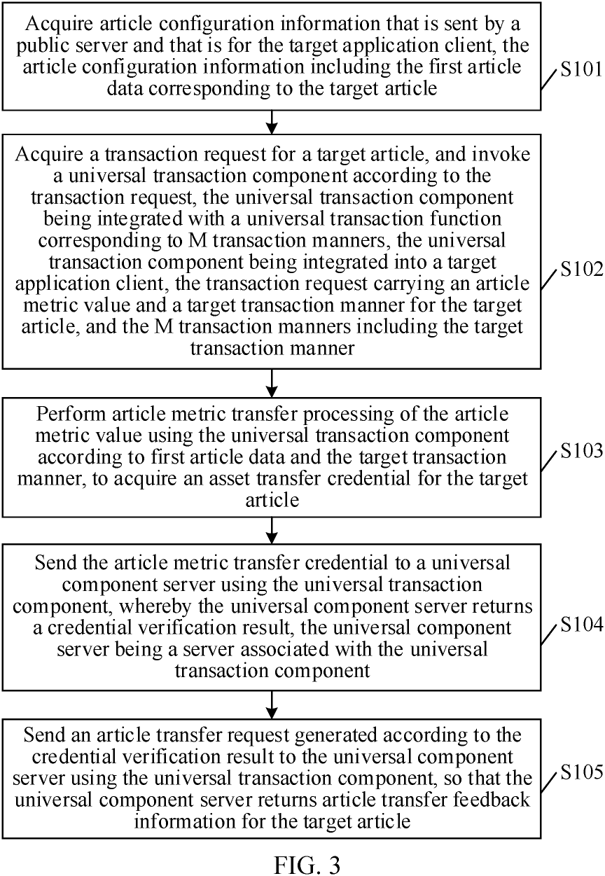

Further, FIG. 3 is a schematic flowchart of a data processing method according to an embodiment of this disclosure. The data processing method may be performed by a computer device. The computer device may include any user terminal in the user terminal cluster 10a in FIG. 1, may include a server (including the public server 10b, the universal component server 10d, the application server cluster 10c, and the transaction server cluster 10e that are shown in FIG. 1) in FIG. 1, and may further include a user terminal and a server. As shown in FIG. 3, the data processing process may include the following steps.

Step S101: Acquire article configuration information that is sent by a public server and that is for the target application client, the article configuration information including the first article data corresponding to the target article.

In some embodiments, the user terminal generates a configuration pull request in response to an article configuration operation on the target application client; sends the configuration pull request to the public server, the public server storing article configuration information, the article configuration information being generated by the public server by separately configuring N articles according to an article configuration component provided by the universal component server, the article configuration information including target article configuration information for the target article, the target article configuration information including the target transaction manner, a target article identifier, and the asset value of the target article, the N articles including the target article, and N being a positive integer; and acquires the article configuration information returned by the public server.

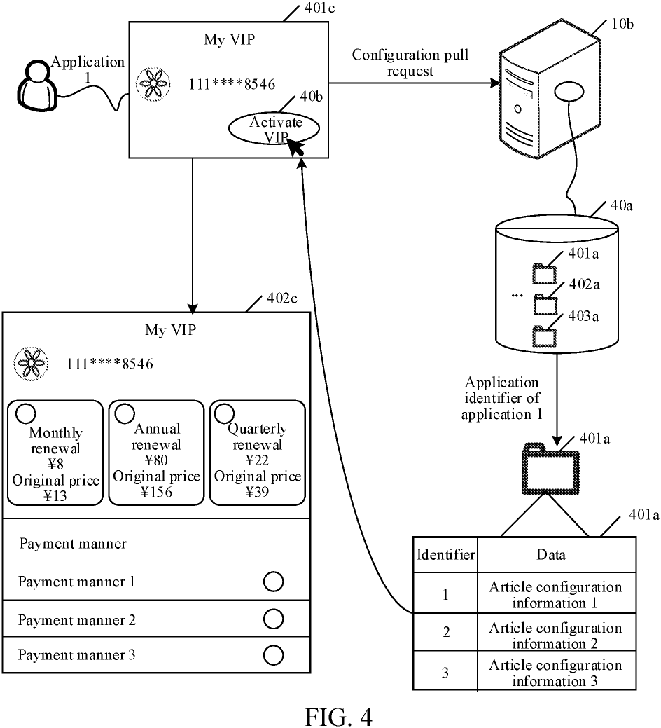

In this embodiment of this disclosure, it is assumed that N is equal to 3. Refer to FIG. 4 together. FIG. 4 is a schematic diagram of a data processing scenario according to an embodiment of this disclosure. As shown in FIG. 4, the user may install the application 1 on the user terminal. The target application server corresponding to the application 1 has integrated, into the application 1 (equivalent to the application client), a universal transaction component that has a universal transaction function jointly corresponding to multiple transaction manners. After the user terminal installs the application 1, the user may register with the application 1. Registration information may include basic information such as a login manner and a nickname. The login manner may include a mobile phone number, an identity card, an authorization login manner of a third-party trusted application, and the like. The registration information and the login manner are not limited herein, and may be set according to an actual application scenario. In this embodiment of this disclosure, a third-party trusted application authorization login manner is used as an example of a login manner. 111****8546 in FIG. 4 may indicate a user account of a user in the third-party trusted application.

Referring to FIG. 4, the user terminal displays a VIP subscription page 401c for the application 1. The user taps a VIP subscription control 40b in the VIP subscription page 401c, and the user terminal 101a may respond to an article configuration operation for the target application client (that is, the application 1) to generate a configuration pull request. As shown in FIG. 4, the user terminal sends the configuration pull request to the public server 10b. The public server 10b may include an information database 40a, and the information database 40a stores article configuration information respectively corresponding to multiple application servers. The multiple application servers herein refer to servers that integrate the universal transaction component into their application clients. As shown in FIG. 4, the information database 40a stores article configuration information 401a, article configuration information 402a, ..., and article configuration information 403a, where the article configuration information 401a, the article configuration information 402a, ..., and the article configuration information 403a are article configuration information respectively corresponding to different application servers. For example, the article configuration information 401a is article configuration information corresponding to the application server 101c, the article configuration information 402a is article configuration information corresponding to the application server 102c, and the article configuration information 403a is article configuration information corresponding to the application server 103c. It may be understood that the article configuration information corresponding to the application server may be sent to the public server 10b after the application server locally configures the article of the application server, or may be obtained after the public server 10b locally configures the article corresponding to each application, which is not limited in this embodiment of this disclosure.

The configuration pull request may carry an application identifier of the application 1, and the application identifier may be equal to a server identifier of a background server corresponding to the application 1, or may be an identifier of a background server corresponding to the application 1. The public server 10b may determine the article configuration information corresponding to the application 1 from the information database 40a according to the application identifier of the application 1. For example, the article configuration information 401a shown in FIG. 4 and the article configuration information 401a include the article configuration information respectively corresponding to three articles. An identifier in the article configuration information 401a may refer to an article identifier, for example, an identifier 1 is an article identifier of an article 1, an identifier 2 is an article identifier of an article 2, and an identifier 3 is an article identifier of an article 3. The data in the article configuration information 401a may refer to the article configuration information respectively corresponding to each article, for example, article configuration information 1 corresponding to the article 1, article configuration information 2 corresponding to the article 2, and article configuration information 3 corresponding to the article 3. The article configuration information corresponding to each article may include a transaction manner, an article identifier, and an asset value. The article configuration information corresponding to each article may include first article data corresponding to the article, and the first article data may include basic data of the article, for example, an article identifier and an asset value (that is, an article value). In this embodiment of this disclosure, data content of the first article data is not limited, and may be set according to an actual application scenario.

Referring to FIG. 4, the public server 10b returns the article configuration information 401a to the user terminal, and the user terminal may switch the VIP subscription page 401c to an article selection page 402c, where the “monthly renewal” displayed on the article selection page 402c may be an article name of the article 1, and CNY 8 corresponding to the “monthly renewal” may be the asset value of the article 1, that is, a value of the article is CNY 8. Likewise, the “annual renewal” displayed on the article selection page 402c may be an article name of the article 2, and CNY 80 corresponding to the “annual renewal” may be an asset value of the article 2, that is, a value of the article is CNY 80. The “quarterly renewal” displayed on the article selection page 402c may be the name of the article 3. CNY 22 corresponding to the “quarterly renewal” can be the asset value of the article 3, that is, the value of the article is CNY 22. Clearly, the application 1 includes three payment manners (equivalent to three transaction manners), which are respectively a payment manner 1, a payment manner 2, and a payment manner 3. This embodiment of this disclosure sets no limitation on the payment manner. The payment manner may be a payment manner supported by the application 1, may be a payment manner supported by a third-party payment application, or may be a payment manner carried in an operating system corresponding to the user terminal.

It may be understood that the article configuration information 401a corresponding to the application 1 may not only be acquired from the public server 10b by the user terminal according to the configuration pull request, but also be actively sent by the public server 10b to the user terminal. For example, if the article configuration information for the application 1 in the information database 40a is updated, the public server 10b may send updated article configuration information for the application 1 to the user terminal.

Step S102: Acquire a transaction request for a target article, and invoke a universal transaction component according to the transaction request, the universal transaction component being integrated with a universal transaction function corresponding to M transaction manners, the universal transaction component being integrated into a target application client, the transaction request carrying an asset value and a target transaction manner for the target article, M being a positive integer, and the M transaction manners including the target transaction manner.

In some embodiments, in response to a transaction operation on the target article, the user terminal generates a transaction request for the target article according to the identifier of the target article.

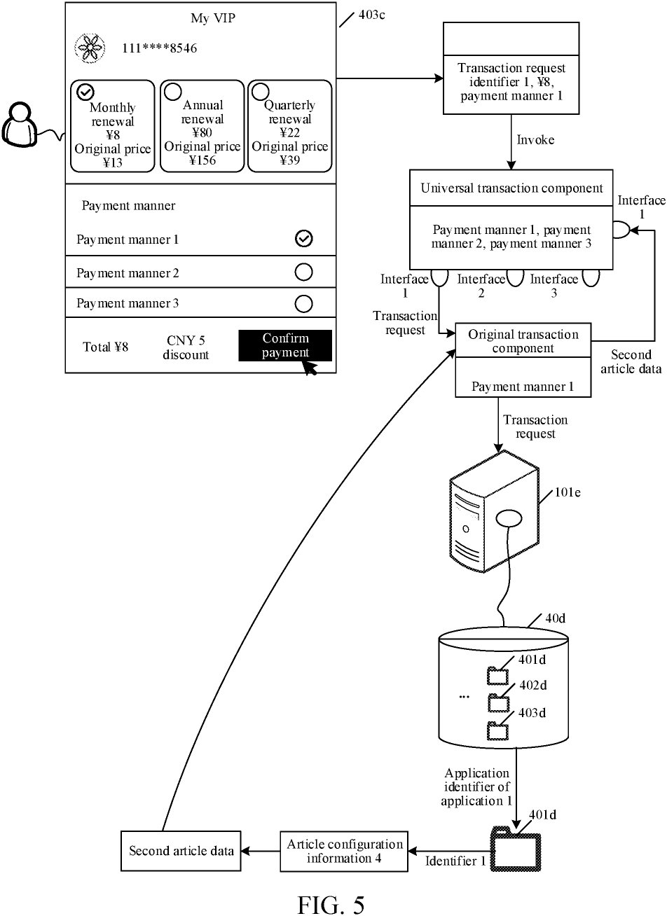

In this embodiment of this disclosure, assuming that M is equal to 3, it may be understood that M and N are not associated. Referring to FIG. 5 together, FIG. 5 is a schematic diagram of a data processing scenario according to an embodiment of this disclosure. With reference to FIG. 5 and step S101 (including FIG. 4), when the user taps the article 1 in the article selection page 402c (that is, the “monthly renewal” product in FIG. 5) and the payment manner 1, and then taps the “confirm payment” control in the article selection page 403c, the user terminal may determine that the “monthly renewal” product is the target article, and the payment manner 1 is the target transaction manner. In this case, the user terminal responds to a transaction operation for the target article, and may generate a transaction request for the target article according to the identifier of the target article (that is, the identifier 1 shown in FIG. 4).

Still referring to FIG. 5, the transaction request may carry basic data for the target article, for example, an asset value (that is, CNY 8 of the example in FIG. 5), a target transaction manner (that is, the payment manner 1), and a target article identifier (that is, the identifier 1). In this embodiment of this disclosure, basic data for the target article carried in the transaction request is not limited, and may be set according to an actual application scenario.

The user terminal may invoke the universal transaction component according to the transaction request. The component may be understood as a code set. The code set is for a specific function, and may accelerate development iterations and improve development efficiency. The universal transaction component in this embodiment of this disclosure may be understood as a payment component. The payment component is a form of code organization for a payment manner, that is, all payment manners (equivalent to the M transaction manners) are integrated together, and a corresponding payment function is provided. The universal transaction component may meet requirements of different application developers for connecting the payment function to an application package. The universal transaction component in this embodiment of this disclosure is a universal payment component provided by the universal component server. The universal component server is configured to perform payment interconnection work with different transaction servers, so as to generate a universal transaction component and provide the universal transaction component to different application servers, so that payment interconnection work between the application server and different transaction servers can be avoided, and payment function development time and payment function upgrade time of the application server can be saved.

Still referring to FIG. 5, the universal transaction component may include three transaction manners, for example, the payment manner 1, the payment manner 2, and the payment manner 3 in FIG. 5.

Step S103: Perform asset transfer processing on a to-be-transferred asset corresponding to the asset value by using the universal transaction component according to first article data and the target transaction manner, to acquire an asset transfer credential for the target article.

In some embodiments, the user terminal sends the transaction request to a target transaction server according to the target transaction manner by using the universal transaction component, so that the target transaction server returns second article data associated with the target article, the target transaction server being a server having a transaction function for the target transaction manner; generates an article transfer pre-request for the target article according to the first article data and the second article data; and performs asset transfer processing on the to-be-transferred asset corresponding to the asset value according to the article transfer pre-request by using the universal transaction component, and acquires the asset transfer credential for the target article according to an asset transfer processing result.

A process of acquiring the second article data may include: The user terminal invokes a target transaction interface that is in the universal transaction component and that is corresponding to the target transaction manner; transmits the transaction request to an original transaction component corresponding to the target transaction manner by using the target transaction interface; the user terminal sends the transaction request to the target transaction server by using the original transaction component, so that the target transaction server determines the second article data corresponding to the target article from article data respectively corresponding to P articles, and returns the second article data to the original transaction component, P being a positive integer; and the user terminal acquires, by using the target transaction interface, the second article data returned by the original transaction component.

The transaction request carries the target article identifier for the target article, and the target transaction server acquires the second article data of the target article according to the target article identifier.

Article data corresponding to the same article in the target transaction server and the public server may be different (for example, the article data in the target transaction server is updated, but the article data in the public server is not updated in time). Therefore, to ensure accuracy of asset transfer in a subsequent article transfer process, a process of generating the article transfer pre-request may include: comparing the first article data with the second article data; generating an article error data prompt for the target article when the first article data and the second article data are different; and generating the article transfer pre-request for the target article when the first article data and the second article data are the same.

The process of acquiring the asset transfer credential may include: The user terminal sends the article transfer pre-request to the universal component server by using the universal transaction component, so that the universal component server performs validity verification on the article transfer pre-request, and generates a pre-request reply result according to a validity verification result; the user terminal acquires, by using the universal transaction component, the pre-request reply result returned by the universal component server, the pre-request reply result including a first reply result or a second reply result, the first reply result being used for indicating that a validity verification result for the article transfer pre-request by the universal component server is an invalid result, and the second reply result being used for indicating that the validity verification result is a valid result; generates a pre-request failure prompt for the target article when the pre-request reply result is the first reply result; if the pre-request reply result is the second reply result, performs asset transfer processing on the to-be-transferred asset corresponding to the asset value by using the universal transaction component, to obtain the asset transfer processing result, the asset transfer processing result including a first processing result or a second processing result, the first processing result being used for representing that asset transfer processing of the to-be-transferred asset succeeds, and the second processing result being used for representing that asset transfer processing of the to-be-transferred asset fails; generates an asset transfer failure prompt for the to-be-transferred asset when the asset transfer processing result is the second processing result; generates an asset transfer notification for the target article when the asset transfer processing result is the first processing result; invokes a target transaction interface that is in the universal transaction component and that is corresponding to the target transaction manner, and transmits, by using the target transaction interface, the asset transfer notification to an original transaction component corresponding to the target transaction manner; sends the asset transfer notification to the target transaction server by using the original transaction component, so that the target transaction server performs a verification operation on the asset transfer notification to obtain a verification result, the verification result including a first verification result or a second verification result, the first verification result being used for representing that the target transaction server acknowledges the asset transfer notification, and the second verification result being used for representing that the target transaction server rejects the asset transfer notification; acquires, by using the original transaction component, an asset transfer failure notification returned by the target transaction server when the verification result is the second verification result; acquires, by using the original transaction component, the asset transfer credential for the target article returned by the target transaction server when the verification result is the first verification result; and returns the asset transfer credential to the universal transaction component by using the target transaction interface.

Still referring to FIG. 5, the universal transaction component may include three transaction manners, for example, the payment manner 1, the payment manner 2, and the payment manner 3 in FIG. 5. An interface 1 in the universal transaction component is a transaction interface corresponding to the payment manner 1, an interface 2 in the universal transaction component is a transaction interface corresponding to the payment manner 2, and an interface 3 in the universal transaction component is a transaction interface corresponding to the payment manner 3. It may be learned from step S102 that the payment manner 1 is the target transaction manner, so that the user terminal can determine that the target transaction interface is the interface 1 shown in the example in FIG. 5. Further, by invoking the interface 1 (that is, the target transaction interface) in the universal transaction component, the user terminal transmits the transaction request to the original transaction component corresponding to the target transaction manner (that is, the payment manner 1 in the example in FIG. 5). It may be understood that if the background server corresponding to the application 1 has a transaction function for the payment manner 1, the original transaction component may be integrated into the application 1. If the payment manner 1 is a transaction function provided by a third-party transaction application, the original transaction component does not exist in the application 1.

By using the original transaction component, the user terminal may send the transaction request to the target transaction server (for example, the transaction server 101e in FIG. 5). The target transaction server is a server that has the transaction function for the target transaction manner. It may be understood that if the background server corresponding to the application 1 has the transaction function for the payment manner 1, the transaction server 101e is equal to the target application server (for example, the application server 101c in FIG. 1), that is, equal to the background server corresponding to the application 1. If the payment manner 1 is a transaction function provided by a third-party transaction application, the transaction server 101e and the target application server are mutually independent servers.

Still referring to FIG. 5, the transaction server 101e may include an information database 40d, and the information database 40d stores article configuration information respectively corresponding to multiple application servers. The multiple application servers herein not only integrate the universal transaction component into their application clients, but also configure their articles to support the payment manner 1. As shown in FIG. 5, the information database 40d stores article configuration information 401d, article configuration information 402d, ..., and article configuration information 403d, where the article configuration information 401d, the article configuration information 402d, ..., and the article configuration information 403d are article configuration information respectively corresponding to different application servers. The transaction request may carry the application identifier of the application 1. The transaction server 101e may determine the article configuration information corresponding to the application 1 from the information database 40d according to the application identifier of the application 1. For the article configuration information 401d shown in FIG. 5, the article configuration information 401d includes the article configuration information corresponding to the article that supports the payment manner 1. It is assumed that the article 2 (that is, the “annual renewal” product) shown in FIG. 4 temporarily does not support the payment manner 1, and the article configuration information 401d does not include the article configuration information corresponding to the article 2.

Referring to FIG. 5, the transaction server 101e may acquire the article configuration information 4 for the article 1 (that is, the target article) from the article configuration information 401d according to the target article identifier (that is, the identifier 1) of the target article, and acquire the second article data for the article 1 from the article configuration information 4 according to the transaction request. It may be understood that a data attribute corresponding to the second article data is the same as a data attribute corresponding to the first article data in step S101, for example, the second article data includes the article identifier and the asset value for the article 1. The transaction server 101e returns the second article data to the original transaction component in the user terminal. By using the target transaction interface, the application client in the user terminal acquires the second article data returned by the original transaction component.

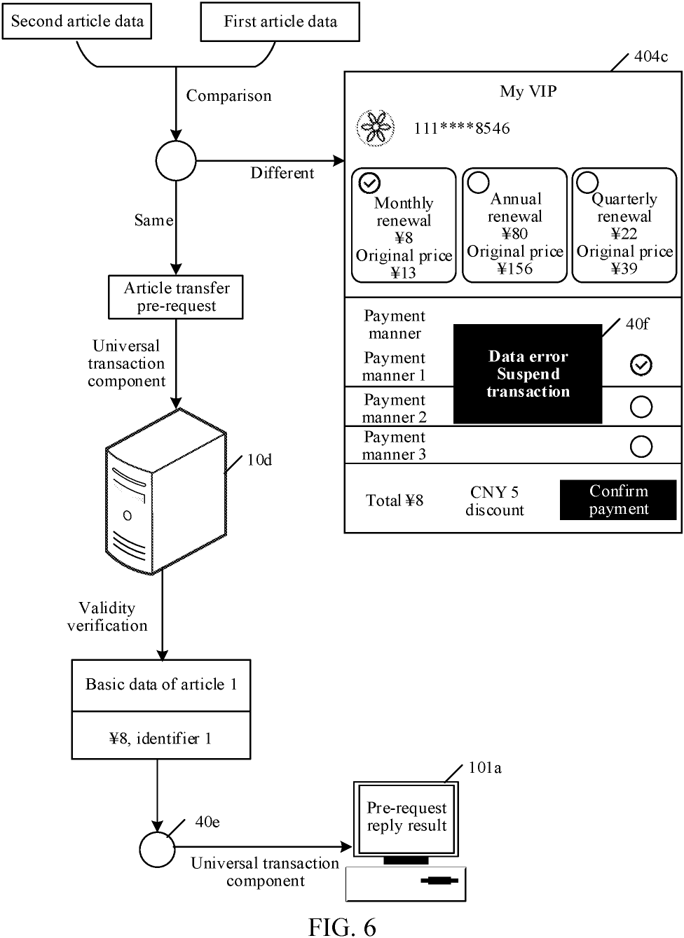

Referring to FIG. 6 together, FIG. 6 is a schematic diagram of a data processing scenario according to an embodiment of this disclosure. As shown in FIG. 6, the user terminal 101a compares the first article data obtained from the public server and the second article data obtained from the target transaction server. If the first article data and the second article data are different, the user terminal 101a may determine that error data exists in the first article data or the second article data. In this case, an article error data prompt for the target article may be generated. As shown in FIG. 6, a sub-page 40f is displayed on an article selection page 404c, and the sub-page 40f may include “data error, transaction paused”, so as to prompt the user that the article cannot be purchased temporarily. If the first article data and the second article data are the same, the user terminal 101a generates an article transfer pre-request for the target article. In this case, the user has not actually performed a payment operation, and the user terminal 101a is still in an audit state for the target article (the article 1 shown in FIG. 6). By using the universal transaction component, the user terminal 101a sends the article transfer pre-request to the universal component server 10d. The universal component server 10d includes article configuration information corresponding to an application integrated with the universal transaction component.

It may be understood that the article transfer pre-request carries basic data of the article 1. The basic data may include the target article identifier (that is, the identifier 1) and the asset value. This embodiment of this disclosure does not limit the basic data of the article 1 carried in the article transfer pre-request, and may be set according to an actual application scenario. After acquiring the article transfer pre-request, the universal component server 10d performs validity verification on the article 1. First, the universal component server 10d obtains, according to the identifier 1, the article data associated with the identifier 1 from the article configuration information in a local database. If there is no article data associated with the identifier 1 in the local database, the universal component server 10d may determine a validity verification result for the article transfer pre-request 40e as an invalid result. If there is the article data associated with the identifier 1 in the local database, the universal component server 10d compares the article data associated with the identifier 1 and the basic data of the article 1. If the two are different, the universal component server 10d may determine that the validity verification result 40e for the article transfer pre-request is an invalid result, and if the two are the same, may determine that the validity verification result 40e for the article transfer pre-request is a valid result. The universal component server 10d generates a pre-request reply result according to the validity verification result 40e, and returns the pre-request reply result to the user terminal 101a by using the universal transaction component.

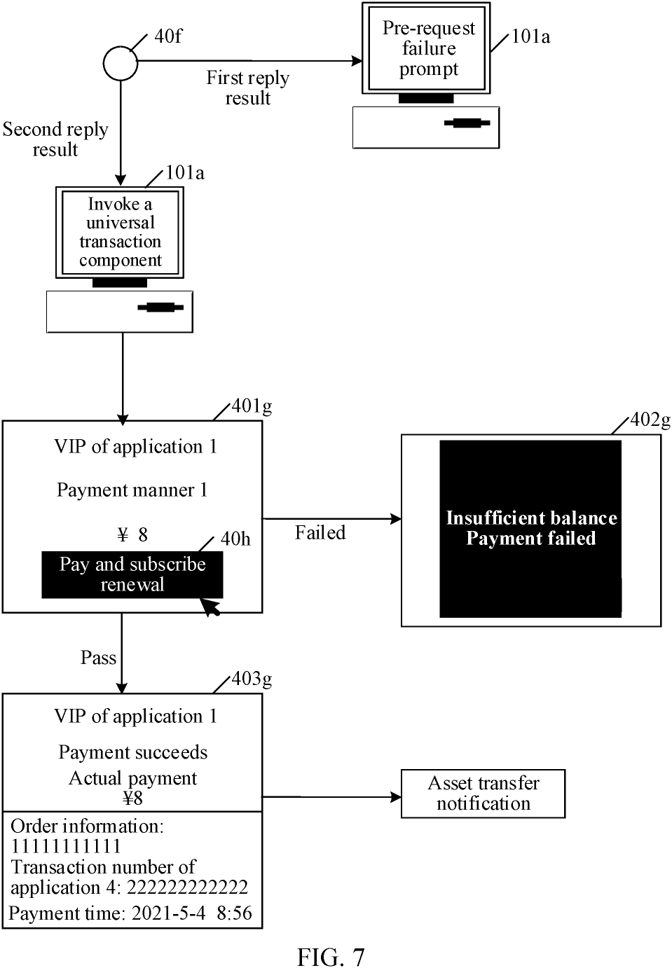

Referring to FIG. 7 together, FIG. 7 is a schematic diagram of a data processing scenario according to an embodiment of this disclosure. The pre-request reply result 40f returned by the universal component server includes two results, which are respectively a first reply result or a second reply result, where the first reply result is used for representing that the validity verification result of the universal component server for the article transfer pre-request is an invalid result, and the second reply result is used for representing that the validity verification result is a valid result. If the pre-request reply result 40f is the first reply result, the user terminal 101a may generate a pre-request failure prompt for the target article; and if the pre-request reply result 40f is the second reply result, perform asset transfer processing on the to-be-transferred asset corresponding to the asset value (for example, CNY 8 shown in FIG. 7) by using the universal transaction component. In a feasible implementation, as shown in FIG. 7, the user terminal 101a displays a payment page 401g, where the payment page 401g may include an application name (in this embodiment of this disclosure, the application 1 is used as the application name), an article in the application (in this embodiment of this disclosure, a VIP membership of this application 1 is used as the article), the asset value of the target article, and a control 40h (in this embodiment of FIG. 7, “pay and enable renewal”). When the user taps the control 40h, the user terminal 101a performs asset transfer processing on the to-be-transferred asset. Further, the user terminal 101a obtains an asset transfer processing result for the target article according to the asset transfer processing. If the asset transfer processing for the to-be-transferred asset is used, it is determined that the asset transfer processing result is a first processing result. In this case, the user terminal 101a may display a payment success page 403g, and in addition to displaying the application name, the article name, and the actual payment price (which may be equal to the to the to-be-transferred asset), the payment success page 403g may display order information for the target article, as shown in “11111111111” in the example of FIG. 7. The transaction number of the application 4 may also be displayed, as shown in “222222222222” in the example in FIG. 7. The application 4 is the application name of a third-party payment application to which the payment manner 1 belongs, and may further include a payment time, for example, 2021.5.4 8:56 in FIG. 7. Further, the user terminal 101a may generate an asset transfer notification. If the asset transfer processing of the to-be-transferred asset fails, the user terminal 101a may determine that the asset transfer processing result is a second processing result. In this case, an asset transfer failure prompt for the to-be-transferred asset is generated, such as a payment failure page 402g shown in FIG. 7. The payment failure page 402g may display a prompt “insufficient balance, payment failed”. It may be understood that FIG. 7 shows only one reason for a payment failure, and another reason may cause the payment failure, such as a network failure, which is not limited herein.

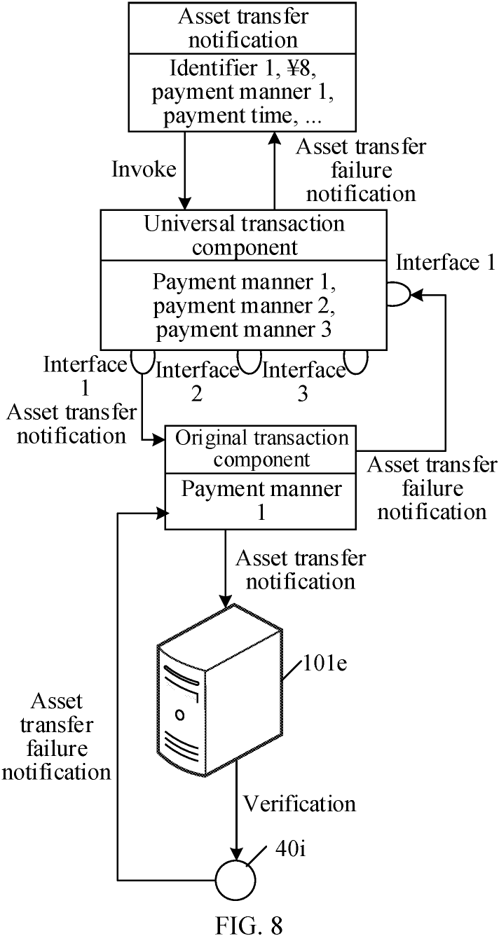

Further, referring to FIG. 8 together, FIG. 8 is a schematic diagram of a data processing scenario according to an embodiment of this disclosure. As shown in FIG. 8, the asset transfer notification may include a target article identifier (an identifier 1 in the example shown in FIG. 8), an actual payment amount (CNY 8 in the example shown in FIG. 8, equal to the asset value), a target transaction manner (a payment manner 1 in the example shown in FIG. 8), a payment time, and the like. In this embodiment of this disclosure, data content carried in the asset transfer notification is not limited, and may be set according to an actual application scenario. The user terminal invokes a target transaction interface (for example, an interface 1 in FIG. 8) that is in the universal transaction component and that is corresponding to the target transaction manner, and transmits, by using the target transaction interface, the asset transfer notification to an original transaction component corresponding to the target transaction manner. By using the original transaction component, the user terminal sends the asset transfer notification to the target transaction server (for example, the transaction server 101e in FIG. 8, which is equivalent to the transaction server 101e in FIG. 1). After receiving the asset transfer notification, the target transaction server may perform a verification operation on the data carried in the asset transfer notification. If the target transaction server rejects the data in the asset transfer notification, it may be determined that the verification result is a second verification result, which may be understood as a failure in placing an order for the target article by the user terminal. In this case, the target transaction server (that is, the transaction server 101e) returns an asset transfer failure notification to the original transaction component in the user terminal, and acquires, by using the interface 1, the asset transfer failure notification sent by the original transaction component, as shown in FIG. 8.

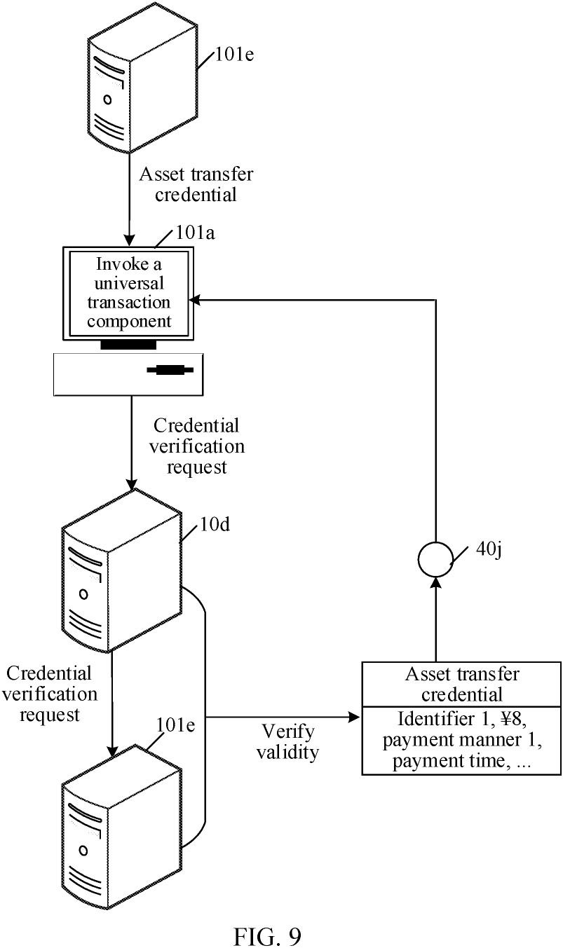

Referring to FIG. 8, if the target transaction server acknowledges the data in the asset transfer notification, it may be determined that the verification result is a first verification result, which may be understood as a successful order placing operation performed by the user terminal on the target article. In this case, the target transaction server returns the asset transfer credential to the original transaction component in the user terminal, and acquires, by using the interface 1 in the universal transaction component, the asset transfer credential sent by the original transaction component. Referring to FIG. 9, FIG. 9 is a schematic diagram of a data processing scenario according to an embodiment of this disclosure.

Step S104: Send the asset transfer credential to a universal component server by using the universal transaction component, so that the universal component server returns a credential verification result, the universal component server being a server associated with the universal transaction component.

In some embodiments, the user terminal generates a credential verification request including an asset transfer credential; sends the credential verification request to the universal component server by using the universal transaction component, so that the universal component server returns the credential verification result for the asset transfer credential, the credential verification result being obtained by the universal component server and a target transaction server by performing validity verification on the asset transfer credential; and the user terminal acquires the credential verification result by using the universal transaction component.

Referring to FIG. 9 again, the user terminal 101a generates a credential verification request according to the asset transfer credential, where the asset transfer credential may include a target article identifier (the identifier 1 in the example shown in FIG. 9), an actual payment amount (CNY 8 in the example shown in FIG. 9, equal to the asset value), a target transaction manner (the payment manner 1 in the example shown in FIG. 9), and a payment time. In this embodiment of this disclosure, data content carried in the asset transfer credential is not limited, and may be set according to an actual application scenario. The user terminal 101a sends the credential verification request to the universal component server 10d by using the universal transaction component. The universal component server 10d may perform validity verification on the asset transfer credential carried in the credential verification request, that is, verify whether the data included in the asset transfer credential is real data and no invalid data exists. If the verification result of the universal component server 10d for the data in the asset transfer credential is an invalid data result, the universal component server 10d may send the invalid data result to the target transaction server (that is, the transaction server 101e). In this case, the transaction server 101e may determine the credential verification result 40j according to the invalid data result. If the verification result of the universal component server 10d for the data in the asset transfer credential is a valid data result, the universal component server 10d may send the credential verification request to the transaction server 101e. After obtaining the credential verification request, the transaction server 101e performs validity verification on the asset transfer credential carried in the credential verification request, and determines a credential verification result 40j according to the validity verification result.

The transaction server 101e returns the credential verification result 40j to the universal component server 10d, so that the universal component server 10d returns the credential verification result 40j for the asset transfer credential to the user terminal 101a.

Step S105: Send an article transfer request generated according to the credential verification result to the universal component server by using the universal transaction component, so that the universal component server returns article transfer feedback information for the target article.

In some embodiments, the credential verification result includes a verification success result or a verification failure result, the verification success result is used for representing that the asset transfer credential passes validity verification by the target transaction server, and the verification failure result is used for representing that the asset transfer credential fails validity verification by the target transaction server; a credential verification failure prompt is generated when the credential verification result is the verification failure result; the article transfer request for the target article is generated when the credential verification result is the verification success result; the article transfer request is sent to the universal component server by using the universal transaction component, so that the universal component server returns the article transfer feedback information for the target article, the article transfer feedback information being obtained by verifying the article transfer request by the universal component server, a public server, and a target application server, and the target application server referring to a background server corresponding to the target application client; and the article transfer feedback information is acquired by using the universal transaction component.

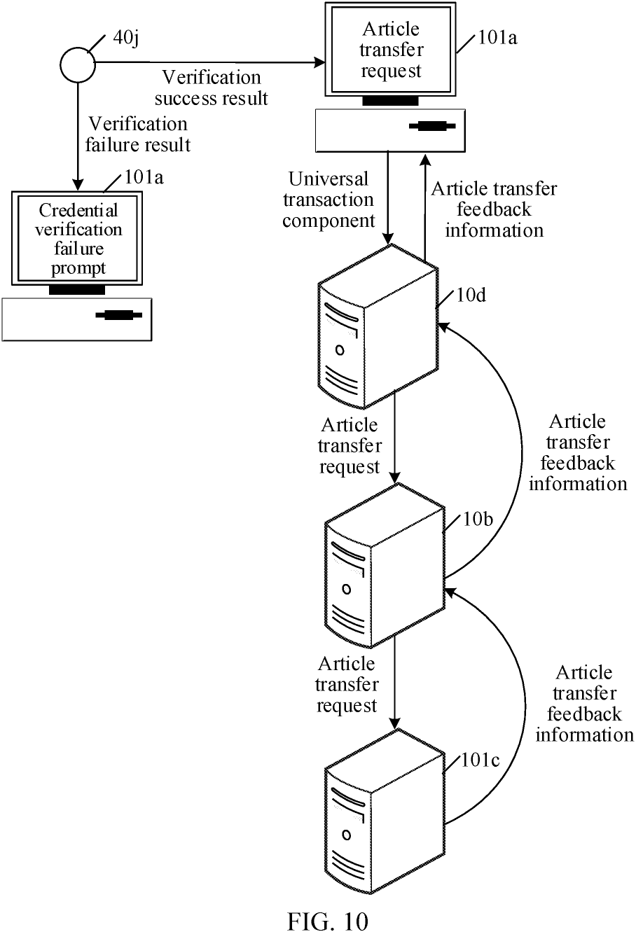

Referring to FIG. 10 together, FIG. 10 is a schematic diagram of a data processing scenario according to an embodiment of this disclosure. With reference to FIG. 10 and step S104, there are two cases of the credential verification result 40j, that is, a verification success result or a verification failure result. If the universal component server 10d returns the verification failure result, the user terminal 101a may generate a credential verification failure prompt according to the verification failure result; and if the universal component server 10d returns the verification success result, the user terminal 101a may generate an article transfer request for the target article. As shown in FIG. 10, the user terminal 101a sends the article transfer request to the universal component server 10d by using the universal transaction component. In this case, the universal component server 10d may verify the data in the article transfer request. If the universal component server 10d acknowledges the data in the article transfer request, the article transfer request is sent to the public server 10b. Likewise, the public server 10b verifies the data in the article transfer request. If the public server 101a acknowledges the data in the article transfer request, the article transfer request is sent to the target application server (that is, the application server 101c shown in FIG. 10). Similarly, the application server 101c verifies the data in the article transfer request. If the universal component server 10d acknowledges the data in the article transfer request, the public server 10b generates the article transfer feedback information for the target article, and returns the article transfer feedback information to the user terminal 101a in a sequence shown in FIG. 10. In the foregoing verification process, if the data in the article transfer request is not acknowledged by a server, the article transfer request is no longer transmitted, an article transfer failure notification may be generated, and the article transfer failure notification is returned to the user terminal 101a.

The interfaces in FIG. 4 to FIG. 9 (for example, the payment failure page 402g in FIG. 7) are merely for ease of describing the example. It may be understood that, in actual application, interface display of the application client corresponding to each application is different. Therefore, in this embodiment of this disclosure, interface content of the application client is not limited, and may be set according to an actual application scenario.

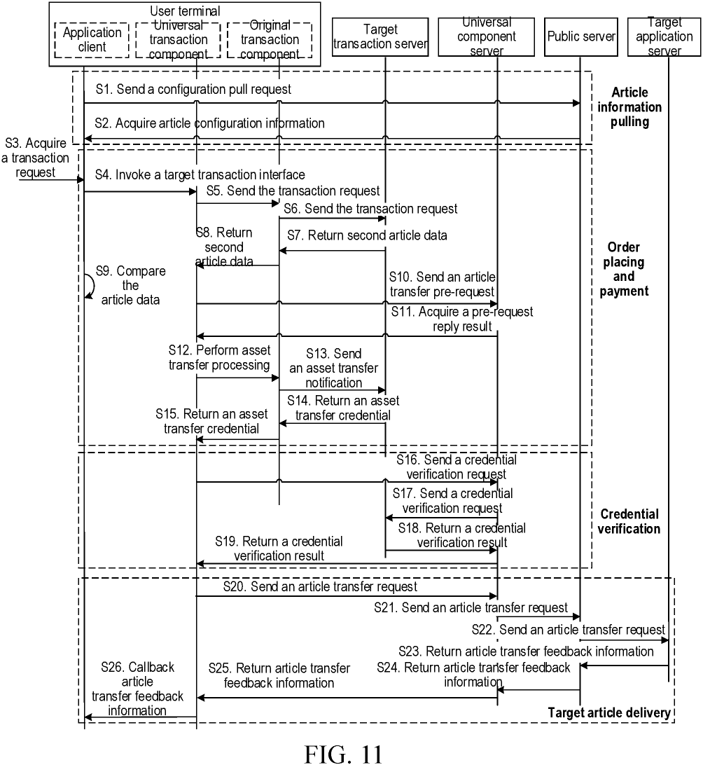

For an embodiment corresponding to FIG. 3, refer to FIG. 11. FIG. 11 is a schematic flowchart of a data processing method according to an embodiment of this disclosure. The data processing method mainly includes four parts: article information pull, order placing and payment, credential verification, and target article shipment.

Part 1: The article information pull mainly includes step S1 and step S2, that is, the user terminal sends the configuration pull request to the public server, and the user terminal acquires the article configuration information returned by the public server. The configuration pull request is used for pulling article display information (which is equivalent to the article configuration information) for the application client, and includes an article unit price, an icon, an article identifier, and the like. For detailed description of this part, refer to the foregoing description in step S101.

Part 2: The order placing and payment mainly includes step S3 to step S15. Step S3: The user terminal acquires a transaction request. Step S4: The user terminal invokes a target transaction interface in a universal transaction component. Step S5: Send the transaction request to an original transaction component by using the target transaction interface. Step S6: Send the transaction request to a target transaction server by using a native transaction interface. Step S7: The target transaction server returns second article data. Step S8: Acquire, by using the universal transaction component, the second article data returned by the native transaction interface. Step S9: An application client compares article data, where the article data includes first article data and the second article data, and the first article data is determined from article configuration information. Step S10: The user terminal sends an article transfer pre-request to a universal component server by using the universal transaction component. Step S11: Acquire, by using the universal transaction component, a pre-request reply result returned by the universal component server. Step S12: The user terminal performs asset transfer processing. Step S13: Send an asset transfer notification to the target transaction server by using an original transaction interface. Step S14: Acquire, by using the original transaction interface, an asset transfer credential returned by the target transaction server. Step S15: Acquire, by using the universal transaction component, the asset transfer credential returned by the original transaction interface. For detailed description of this part, refer to the foregoing description in step S102 and step S103.

Part 3: The credential verification mainly includes step S16 to step S19. Step S16: Send a credential verification request to the universal component server by using the universal transaction component. Step S17: The universal component server sends the credential verification request to the target transaction server. Step S18: The target transaction server returns a credential verification result to the universal component server. Step S19: Acquire, by using the universal transaction component, the credential verification result returned by the universal component server. For detailed description of this part, refer to the foregoing description in step S104.

Part 4: The delivery of the target article mainly includes step S20 to step S26. Step S20: Send an article transfer notification to the universal component server by using the universal transaction component. Step S21: The universal component server sends an article transfer request to a public server. Step S22: The public server sends the article transfer request to a target application server. Step S23: The target application server returns article transfer feedback information to the public server. Step S24: The public server returns the article transfer feedback information to the universal component server. Step S25: Acquire, by using the universal transaction component, the article transfer feedback information returned by the universal component server. Step S26: Recall the article transfer feedback information to an application client. For detailed description of this part, refer to the foregoing description in step S105.

In conclusion, the embodiments of this application have the following advantages:

1. Currently, the development cost of the application client is high. In the same payment manner, each application client accesses the application client independently, which causes a high cost. When there are many payment manners, access interfaces corresponding to the payment manner are different, resulting in high interconnection costs. Through the universal transaction function of the universal transaction component, the application client can support multiple payment manners (i.e., transaction manners) without directly interfacing with a third-party payment application.

2. An access effect of a current payment manner cannot be ensured, and access details are numerous. In addition, a development level of an application developer is different, and a success rate of a payment function in an application client of the application developer cannot be ensured. By using a universal transaction component, the application developer does not need to specifically access an interface for each payment manner in the application client.

3. An access operation platform can meet operation requirements better, and perform operation experiments through an AB-Test.

In the embodiments of this application, the universal transaction component is integrated with a universal transaction function corresponding to multiple transaction manners. Therefore, by integrating the universal transaction component into the target application client, not only the article in the target application client can be purchased by a user in multiple payment manners (that is, the foregoing M transaction manners), but also access efficiency of the application developer integrating multiple payment manners into the target application client can be improved. In addition, in the embodiments of this application, both the asset transfer credential and the credential verification result can be sent to the universal component server by using the universal transaction component, so that the universal component server performs a corresponding operation and returns a result (including the foregoing credential verification result and article transfer feedback information). In a user payment process, verification processing on a transaction request that is only concentrated on the target application server (a background server corresponding to the target application client) can be avoided, and payment efficiency and accuracy of the user can be improved.

Further, referring to FIG. 12, FIG. 12 is a schematic flowchart of a data processing method according to an embodiment of this disclosure. The data processing method may be performed by a computer device. The computer device may include any user terminal in the user terminal cluster 10a in FIG. 1, may include a server (including the public server 10b, the universal component server 10d, the application server cluster 10c, and the transaction server cluster 10e that are shown in FIG. 1) in FIG. 1, and may further include a user terminal and a server. As shown in FIG. 12, the data processing process includes the following steps.

Step S201: Acquire an article configuration request for a target application client, the target application client being integrated with a universal transaction component, the universal transaction component being integrated with a universal transaction function corresponding to M transaction manners, M being a positive integer, the M transaction manners including a target transaction manner, and an article in the target application client including a target article.

Step S202: Invoke an article configuration component according to the article configuration request, and configure the article in the target application client by using the article configuration component, to generate article configuration information, the article configuration component being provided by a universal component server, the universal component server being a server associated with the universal transaction component, and the article configuration information including first article data corresponding to the target article.

Step S203: Acquire a configuration pull request that is sent by a user terminal and that is for the target application client, and send the article configuration information to the user terminal according to the configuration pull request, so that the user terminal invokes the universal transaction component in a case of obtaining a transaction request for the target article, and performs article transaction processing on the target article according to the first article data and the target transaction manner carried in the transaction request, the user terminal referring to a terminal on which the target application client is installed.

In some embodiments, the article configuration component is invoked according to the article configuration request, the article configuration component being integrated with a universal configuration function corresponding to W configuration manners, W being a positive integer, and the W configuration manners including a configuration region manner; a region transaction manner corresponding to a configuration region is acquired from the M transaction manners in response to a trigger operation on the configuration region manner, and the article in the target application client is configured according to an association relationship between the configuration region and the region transaction manner, to generate the article configuration information; and a terminal region to which a network address of the user terminal belongs is acquired according to the configuration pull request; a target region transaction manner corresponding to the terminal region is determined according to the association relationship between the configuration region and the region transaction manner; and the article configuration information that carries the target region transaction manner is sent to the user terminal.

In another implementable manner, the article configuration component is invoked according to the article configuration request, W being a positive integer, and W configuration manners including a configuration transaction manner; a to-be-configured article is acquired from the article in the target application client in response to a trigger operation on the configuration transaction manner; and when a recommended transaction manner that is for the to-be-configured article and that is sent by the universal component server is obtained, the to-be-configured article is configured according to the recommended transaction manner to generate the article configuration information.

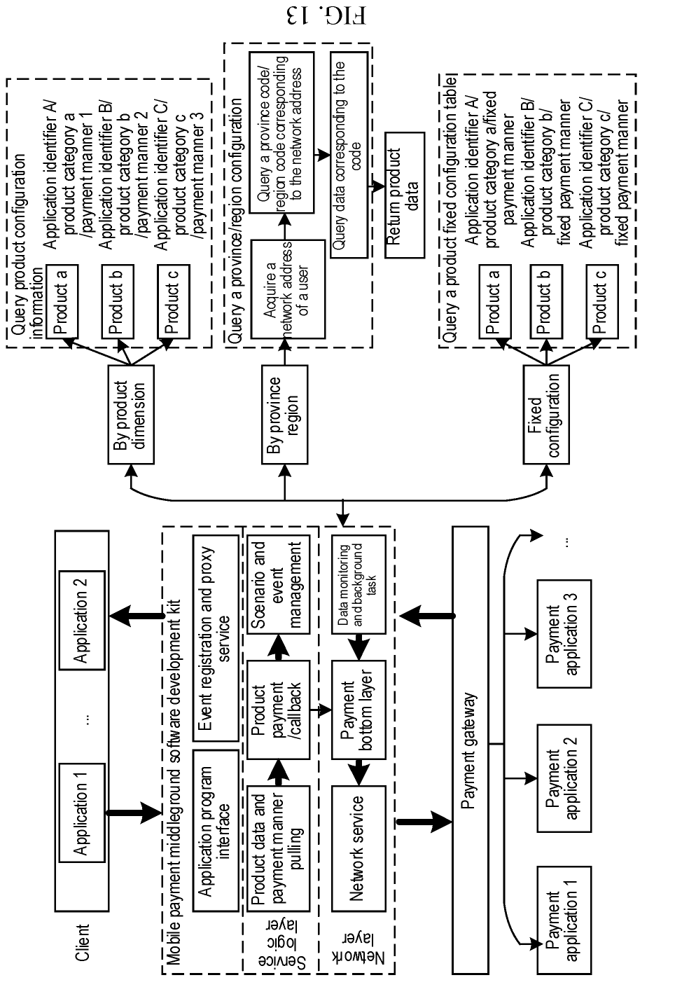

In some embodiments, referring to FIG. 13 together, FIG. 13 is a schematic architecture diagram of an article configuration according to an embodiment of this disclosure. As shown in FIG. 13, functions of the left part in FIG. 13 are consistent with those of the left part in FIG. 2. Referring to the right side of FIG. 13, that is, configuration for an article in a target application client. This embodiment of this disclosure may provide three basic configuration manners. In actual configuration, an article may be configured according to an actual application scenario with reference to two or three basic configuration manners.

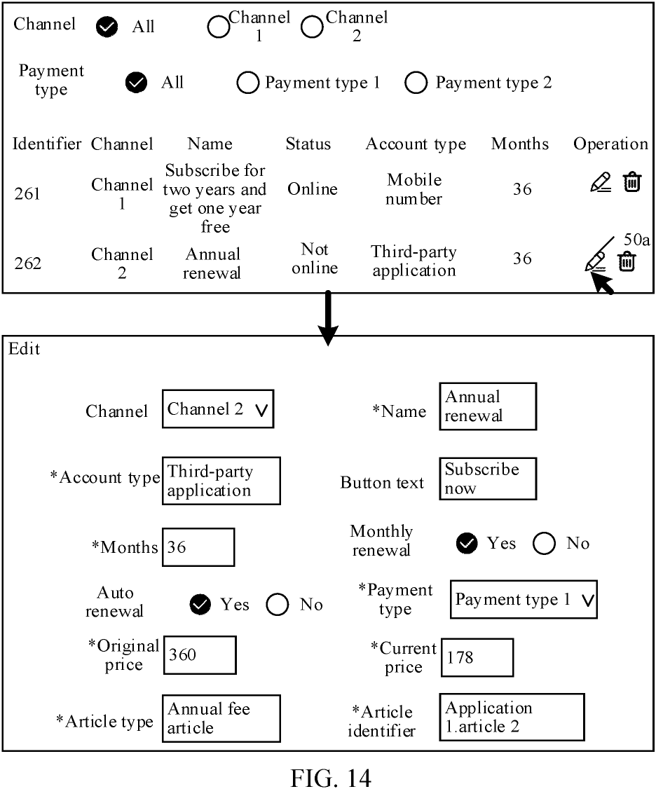

A first configuration manner is a configuration transaction manner, which is equivalent to a configuration manner according to a product dimension in FIG. 13. Referring to FIG. 14 together, FIG. 14 is a schematic diagram of a data processing scenario according to an embodiment of this disclosure. Channels in FIG. 14 may include two channels, that is, a channel 1 and a channel 2. The channel is used for representing a channel through which an application client can be acquired. In actual application, there may be any quantity of channels. This is not limited in this embodiment of this disclosure. A payment type in FIG. 14 is equivalent to the foregoing transaction manner. In this embodiment of this disclosure, two payment types are used as examples, that is, a payment type 1 and a payment type 2. A state in FIG. 14 is used for indicating whether the application client is online, that is, whether the user terminal can install the application client, and an account type is used for indicating a manner in which the user can log in to the application client. It may be understood that in this embodiment of this disclosure, only the foregoing factors (for example, the identifier and the channel) are used for describing the configuration interface. In actual application, the configuration interface may include another factor.

In this embodiment of this disclosure, that a public server configures an article in a target application client is used as an example to describe a process of generating the article configuration information. In actual application, the target application server may configure an article (that is, a product) of the target application server to generate article configuration information for the target application client, and then send the article configuration information to the public server. As shown in FIG. 14, an embodiment of this disclosure shows that the identifier of the target article is an identifier 262, the target article is an article corresponding to the identifier 262, and the public server responds to a configuration operation for the target article in the target application client, that is, configures that the user taps a modification control 50a for the target article, and a display screen corresponding to the public server may display an editing page, where it may be configured that the user can select a channel for the target article on the editing page (such as the channel 2 shown in FIG. 14), fill in a name (such as annual renewal shown in FIG. 14), select an account type (such as the third-party application shown in FIG. 14), fill in a button text displayed by the user terminal (such as enable now shown in FIG. 14 and “confirm payment” in FIG. 5), and an effective time corresponding to the target article (36 months shown in FIG. 14), a set payment type for the target article (the payment type 1 shown in FIG. 14), the original price and the current price corresponding to the target article (such as the original price 360 and the current price 178 shown in FIG. 14), an article type of the target article (such as the annual fee article shown in FIG. 14), and an article identifier (such as application 1. article 2 shown in FIG. 14). It may be understood that an article identifier that needs to be configured on the configuration page is a real identifier of the target article on each server, and the identifier may be a storage address of the target article on the public server, or may be other unique data. There is a mapping relationship between the article identifier and the identifier 262, that is, if the identifier 262 is obtained by any server, the target article and the article identifier may be determined. Similarly, if the article identifier is obtained by any server, the target article and the identifier 262 corresponding to the article identifier may be determined.

It may be understood that the interface in the example in FIG. 14 is merely for ease of description and understanding. In actual application, for different applications, the public server may be corresponding to different configuration interfaces, or may be corresponding to the same configuration interface. This is not limited in this embodiment of this disclosure.

According to the configuration transaction manner, the public server may configure a payment manner of a single product. In addition, a payment manner of each product supports diversification. Referring to FIG. 13 again, FIG. 13 shows three articles (that is, a product a, a product b, and a product c in FIG. 13). If the product a is configured according to the configuration transaction manner, the public server may configure the product a according to a configuration interface shown in FIG. 14. It is configured that the user may select a payment type for the product a in the option box of the editing page in FIG. 14, so as to obtain product configuration information corresponding to the product a. The product configuration information corresponding to the product a may include an application identifier A (which is equivalent to the identifier 262 in FIG. 14, or may be equivalent to the article identifier in FIG. 14), a product type a (which is equivalent to the annual fee product shown in FIG. 14), and a payment manner 1 (which is equivalent to the payment type 1 shown in FIG. 14). For configuration processes of the product b and the product c, refer to the configuration process of the product a.

A second configuration manner is a configuration region manner, which is equivalent to a province-by-province configuration manner in FIG. 13. The public server presets a corresponding payment manner (which may be one or more payment manners) for each province region. When the user terminal requests the article configuration information of the target application client, the public server may determine a network address corresponding to the user, query a province or region code corresponding to the network address, acquire configuration information (including the payment manner) corresponding to the province or region according to the code, and finally return product data (that is, the article configuration information) to the user terminal. For example, in the configuration region manner, the public server sets payment manners of all users in Guangdong province to a payment manner 1, and sets payment manners of all users in Hubei province to a payment manner 2. When a user terminal 3 whose network address belongs to Guangdong province requests the public server for article configuration information of the application client, the public server may determine, according to an attribute (that is, Guangdong province) of the network address of the public server, that the payment manner in the article configuration information for the user terminal 3 is the payment manner 1. Similarly, the public server may be a user terminal whose network address belongs to Hubei province, and return the article configuration information carrying the payment manner 2.

A third configuration manner is a configuration fixed manner, which is equivalent to the fixed configuration manner in FIG. 13. All products may be configured with the same payment manner. In this case, different payment manners are no longer configured according to a single product.

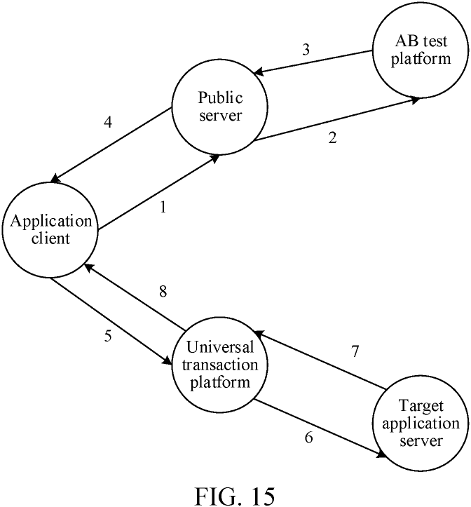

With reference to the embodiments respectively corresponding to FIG. 3 and FIG. 12, references may be made to FIG. 15. FIG. 15 is a schematic diagram of data flow between multiple platforms according to an embodiment of this disclosure. The multiple platforms may include a target application client, a public server, an AB test platform, a universal transaction platform, and a target application server. Steps of data flow between the platforms are described below.

Step 1: Data flow from the target application client to the public server. The target application client is installed in the user terminal, and mainly means that the user terminal requests article configuration information for the target application client from the public server. The article configuration information may include an article name, a price, payment parameter information, a payment manner, and the like. In addition, the target application client reports user parameter information (equivalent to a transaction reporting record) associated with a payment event to the public server by using the universal transaction component.

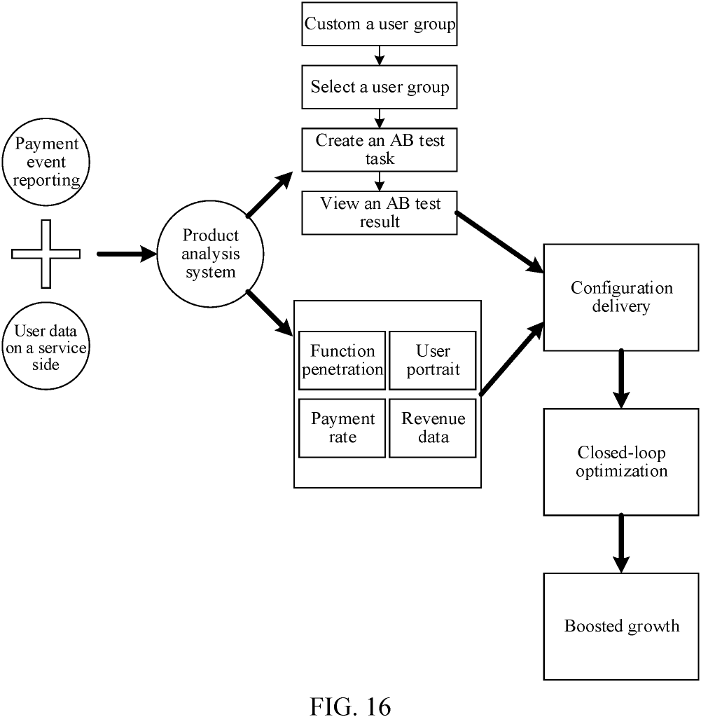

Step 2: Data flow from the public server to the AB test platform. It may be understood that there is a difference in article configuration information of target application clients corresponding to different user terminals. Therefore, when different users purchase an article, there is a difference in user parameter information (which herein mainly refers to data associated with the article) that is generated by the user terminal and that is associated with the payment event. Further, the AB test platform may perform cross-reference tests based on a large quantity of different user parameters. The public server sends the user parameter information to the AB test platform, so as to request the AB test. The AB test platform delivers different configurations according to a user group and a group to which the experiment belongs, and performs a related cross-test. Referring to FIG. 16, FIG. 16 is a basic framework diagram of an AB test according to an embodiment of this disclosure. The public server first acquires payment events of a large quantity of users and user data of a service side (that is, the application client), inputs them to a product analysis system, determines a user portrait, revenue data, a payment rate, and function penetration according to a data analysis result, and creates an AB test. The AB test platform assigns the user to different groups, that is, the user group is user defined, and selects the corresponding user according to the user-defined user group. The AB test platform determines the corresponding user as the target user and creates an AB-Test task.

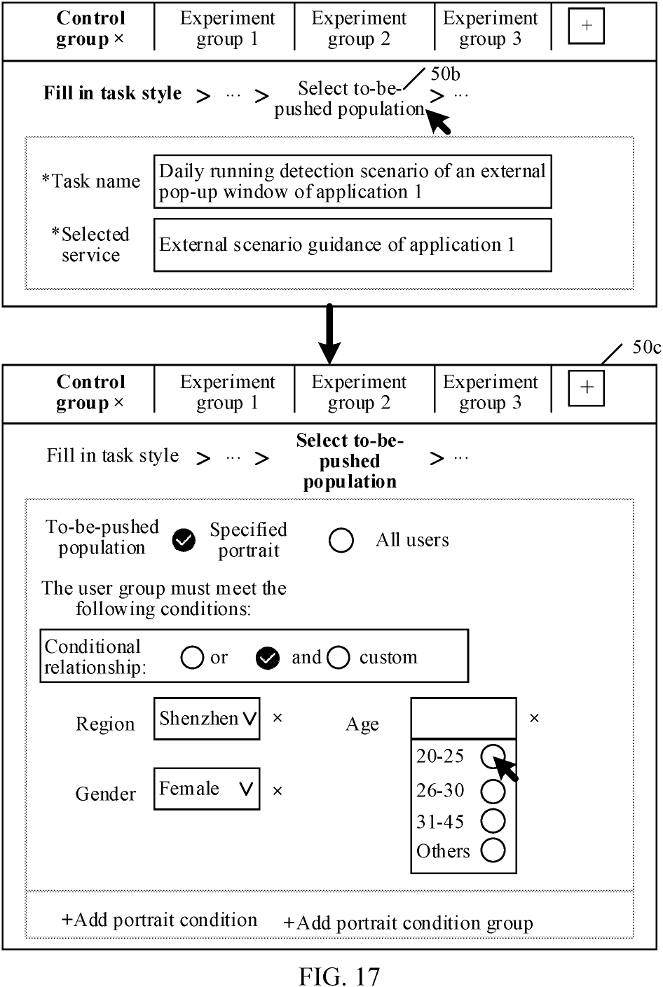

The following briefly describes how to configure parameters respectively corresponding to a control group and an experiment group in the AB test. Referring to FIG. 17, FIG. 17 is a schematic diagram of a data processing scenario according to an embodiment of this disclosure. In this embodiment of this disclosure, it is assumed that there are three experiment groups, that is, an experiment group 1, an experiment group 2, and an experiment group 3 in FIG. 17. The AB test platform first configures data for the control group and each experiment group. As shown in FIG. 17, data that needs to be configured may be divided into task data, to-be-pushed population data, and the like. The task data may include a task name and service data. In FIG. 17, an example task name is “Daily running detection scenario of an external pop-up window of application 1”, and an example selected service is “External scenario guidance of application 1”. It is configured that the user taps the control 50b (that is, the “to-be-pushed population selection” control in the example shown in FIG. 17). The AB test platform may display the configuration page 50c, and the configuration page 50c may include a to-be-pushed population (a specified portrait and a full quantity of users shown in FIG. 17). If it is configured that the user selects a specified user, it is configured that the user 50c may further include a condition that a specified portrait needs to meet. This embodiment of this disclosure exemplifies three conditions, that is, a region, an age, and a gender, where the region is set to Shenzhen, the age is set to a range of 20-25, and the gender is set to women. In this embodiment of this disclosure, the foregoing three conditions are determined by using an “and” relationship. Therefore, a specified portrait of the experiment group is women aged 20-25 in region Shenzhen.

Referring to FIG. 17 again, the configuration page 50c may further include “add a portrait condition”. For example, for the age, a 46-50 condition may be added. The configuration page 50c may further include “add a portrait condition group”, such as occupation or ancestral home. In this embodiment of this disclosure, an experiment parameter of the control group is configured as an example for description. It may be understood that a parameter configuration (a service and a population that are configured may be different) process corresponding to each of the three experiment groups in FIG. 17 is consistent with a parameter configuration process of the control group. It may be understood that FIG. 17 is for ease of description and understanding of the schematic configuration interface. In actual application, the AB test platform displays different configuration pages for different AB tests.

The AB test platform performs a corresponding AB test to obtain an experiment result. The AB test platform may be located on the universal component server, and the universal component server recommends a more appropriate configuration solution for the application according to a user portrait, revenue data, and an experiment result, including setting different article configuration information for different user groups. For example, by using the AB test, it is learned users in different regions prefer to pay in which manners, for example, prompting the application server that users in the southern region prefer to use the payment manner 1, and users in the northern region prefers to use the payment manner 3. For example, through the AB test, it is learned which payment manners users of different age ranges prefer, such as prompting the application server that users aged 15-30 prefer to use the payment manner 1, and users aged over 30 prefer to use the payment manner 3, so as to optimize the application client, and increase the users’ preference for the application client.

In a feasible implementation manner, the AB test platform is located in the public server, and the public server acquires a transaction reporting record for the target article sent by a user terminal in a user terminal cluster, the target application client being installed on the user terminal in the user terminal cluster, and the transaction reporting record including an asset transfer value for the target article and a transaction manner for the target article; creates a cross-reference test experiment according to the asset transfer value and the transaction manner, and executes the cross-reference test experiment to obtain a test experiment result, the test experiment result including a recommended asset value for the target article and a recommended transaction manner for the target article; and the public server updates target article configuration information of the target article according to the recommended asset value and the recommended transaction manner in response to a next article configuration request.

Step 3: Data flow from the AB-Test platform to the public server. According to different experiments configured by the AB-Test, parameter information is returned to the public server. The parameter information includes product data information, payment manner information, and AB-Test experiment parameter information.

Step 4: Data flow from the public server to the target application client. The article configuration information (including product detailed data information and payment manner information) is returned to the target application client. After obtaining the article configuration information, the target application client may perform a related deserialization operation, that is, convert digital data into visual content for display on a page, so that the user purchases the article.

Step 5: Data flow from the target application client to a universal transaction platform. When the user initiates product payment, the target application client transfers data such as the target article identifier for the target article to the universal transaction platform, and performs corresponding payment processing according to a target payment manner. The universal transaction platform returns a payment result to a target transaction server. In this case, the target transaction server performs a related credential verification process. After the credential verification succeeds, subsequent operations and processes are performed.

Step 6: Data flow from the universal transaction platform to a target application server. The universal transaction platform sends an article transfer request to the target application server.

Step 7: Data flow from the target application server to the universal transaction platform. The target application server returns a delivery result (equivalent to the article transfer feedback information) to the universal transaction platform.

Step 8: Data flow from the universal transaction platform to the target application client. The universal transaction platform notifies the target application client to display and prompt the result according to the related result.

A detailed description of the above steps 1 to 8 can be found in the above description of the embodiment corresponding to FIG. 3.

It can be learned from the foregoing that, by integrating the universal transaction component into the target application client, not only the article in the target application client can be purchased by a user in multiple payment manners (that is, the foregoing M transaction manners), but also access efficiency of the application developer integrating multiple payment manners into the target application client can be improved. In addition, in the embodiments of this application, both the asset transfer credential and the credential verification result can be sent to the universal component server by using the universal transaction component, so that the universal component server performs a corresponding operation and returns a result (including the foregoing credential verification result and article transfer feedback information). In a user payment process, verification processing on a transaction request that is only concentrated on the target application server (a background server corresponding to the target application client) can be avoided, and payment efficiency and accuracy of the user can be improved.

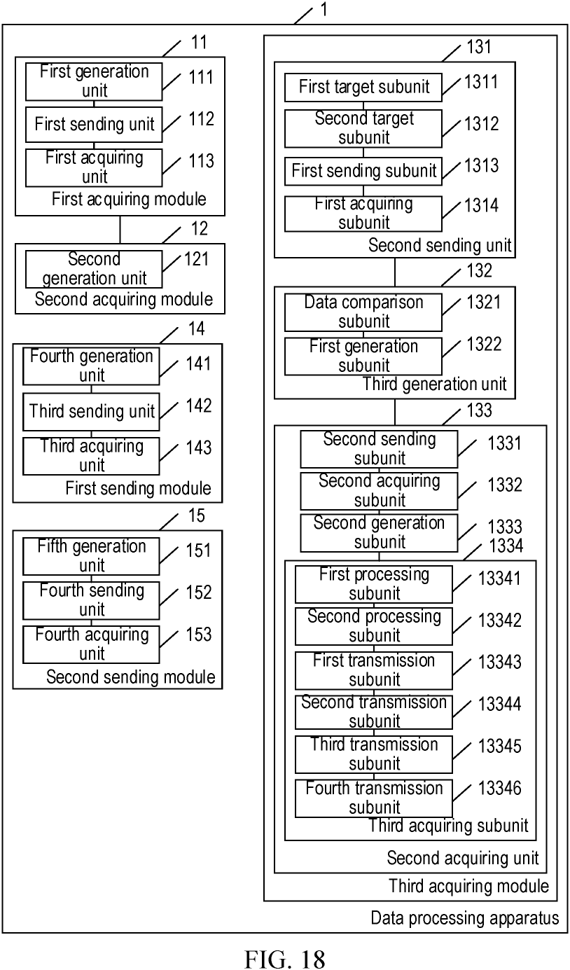

Further, referring to FIG. 18, FIG. 18 is a schematic structural diagram of a data processing apparatus according to an embodiment of this disclosure. The foregoing data processing apparatus may be a computer program (including program code) running in a computer device. For example, the data processing apparatus is application software. The apparatus may be configured to perform corresponding steps in the method provided in the embodiment of this disclosure. As shown in FIG. 18, the data processing apparatus 1 may include: a second acquiring module 12, a third acquiring module 13, a first sending module 14, and a second sending module 15.

The term “module” (and other similar terms such as unit, submodule, etc.) refers to computing software, firmware, hardware, and/or various combinations thereof. At a minimum, however, modules are not to be interpreted as software that is not implemented on hardware, firmware, or recorded on a non-transitory processor readable recordable storage medium. Indeed “module” is to be interpreted to include at least some physical, non-transitory hardware such as a part of a processor, circuitry, or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices. The modules can be implemented in software stored in memory or non-transitory computer-readable medium. The software stored in the memory or medium can run on a processor or circuitry (e.g., ASIC, PLA, DSP, FPGA, or any other integrated circuit) capable of executing computer instructions or computer code. The modules can also be implemented in hardware using processors or circuitry (e.g., second acquiring circuitry, third acquiring circuitry, first sending circuitry, second sending circuitry, etc., which can be implemented on the same or different integrated circuit).

The second acquiring module 12 is configured to acquire a transaction request for a target article, and invoke a universal transaction component according to the transaction request, the universal transaction component being integrated with a universal transaction function corresponding to M transaction manners, the universal transaction component being integrated into a target application client, the transaction request carrying an asset value and a target transaction manner for the target article, M being a positive integer, and the M transaction manners including the target transaction manner;
the third acquiring module 13 is configured to perform asset transfer processing on a to-be-transferred asset corresponding to the asset value by using the universal transaction component according to first article data of the target article and the target transaction manner, to acquire an asset transfer credential for the target article;
the first sending module 14 is configured to send the asset transfer credential to a universal component server by using the universal transaction component, so that the universal component server returns a credential verification result, the universal component server being a server associated with the universal transaction component; and
the second sending module 15 is configured to send an article transfer request generated according to the credential verification result to the universal component server by using the universal transaction component, so that the universal component server returns article transfer feedback information for the target article.

For specific function implementations of the first acquiring module 11, the second acquiring module 12, the third acquiring module 13, the first sending module 14, and the second sending module 15, refer to step S101 to step S105 in the foregoing embodiment corresponding to FIG. 3.

Referring to FIG. 18, the apparatus may further include a first acquiring module 11, and the first acquiring module 11 is configured to: acquire article configuration information that is sent by a public server and that is for the target application client, the article configuration information including the first article data corresponding to the target article.

The first acquiring module 11 may include: a first generation unit 111, a first sending unit 112, and a first acquiring unit 113.

The first sending unit 112 is configured to: send a configuration pull request to the public server in response to an article configuration operation on the target application client, the public server storing article configuration information, the article configuration information being generated by the public server by separately configuring N articles according to an article configuration component provided by the universal component server, the article configuration information including target article configuration information for the target article, the target article configuration information including the target transaction manner, a target article identifier, and the asset value of the target article, the N articles including the target article, and N being a positive integer; and

the first acquiring unit 113 is configured to acquire the article configuration information returned by the public server.

The second acquiring module 12 may include: a second generation unit 121.

The second generation unit 121 is configured to: generate the transaction request for the target article according to the target article identifier in response to a transaction operation on the target article.

For specific function implementations of the first generation unit 111, the first sending unit 112, the first acquiring unit 113, and the second generation unit 121, refer to step S101 and step S102 in the foregoing embodiment corresponding to FIG. 3.

Referring to FIG. 18 again, the third acquiring module 13 may include: a second sending unit 131, a third generation unit 132, and a third acquiring unit 133.

The second sending unit 131 is configured to send the transaction request to a target transaction server according to the target transaction manner by using the universal transaction component, so that the target transaction server returns second article data associated with the target article, the target transaction server being a server having a transaction function for the target transaction manner;
the third generation unit 132 is configured to generate an article transfer pre-request for the target article according to the first article data and the second article data; and
the third acquiring unit 133 is configured to: perform asset transfer processing on the to-be-transferred asset corresponding to the asset value according to the article transfer pre-request by using the universal transaction component, and acquire the asset transfer credential for the target article according to an asset transfer processing result.

For specific function implementations of the second sending unit 131, the third generation unit 132, and the third acquiring unit 133, refer to step S103 in the embodiment corresponding to FIG. 3.

Referring to FIG. 18 again, the second sending unit 131 may include: a first target subunit 1311, a second target subunit 1312, a first sending subunit 1313, and a first acquiring subunit 1314.

The first target subunit 1311 is configured to invoke a target transaction interface that is in the universal transaction component and that is corresponding to the target transaction manner;
the second target subunit 1312 is configured to transmit the transaction request to an original transaction component corresponding to the target transaction manner by using the target transaction interface;
the first sending subunit 1313 is configured to send the transaction request to the target transaction server by using the original transaction component, so that the target transaction server determines the second article data corresponding to the target article from article data respectively corresponding to P articles, and returns the second article data to the original transaction component, P being a positive integer; and
the first acquiring subunit 1314 is configured to acquire, by using the target transaction interface, the second article data returned by the original transaction component.

For specific function implementations of the first target subunit 1311, the second target subunit 1312, the first sending subunit 1313, and the first acquiring subunit 1314, refer to step S103 in the foregoing embodiment corresponding to FIG. 3.

Referring to FIG. 18 again, the third generation unit 132 may include: a data comparison subunit 1321 and a first generation subunit 1322.

The data comparison subunit 1321 is configured to compare the first article data with the second article data;
the first generation subunit 1322 is configured to generate the article transfer pre-request for the target article when the first article data and the second article data are the same; and
the first generation subunit 1322 is further configured to generate an article error data prompt for the target article when the first article data and the second article data are different.

For specific function implementations of the data comparison subunit 1321 and the first generation subunit 1322, refer to step S103 in the embodiment corresponding to FIG. 3.

Referring to FIG. 18 again, the second acquiring unit 133 may include: a second sending subunit 1331, a second acquiring subunit 1332, a second generation subunit 1333, and a third acquiring subunit 1334.

The second sending subunit 1331 is configured to send the article transfer pre-request to the universal component server by using the universal transaction component, so that the universal component server performs validity verification on the article transfer pre-request, and generates a pre-request reply result according to a validity verification result;
the second acquiring subunit 1332 is configured to acquire, by using the universal transaction component, the pre-request reply result returned by the universal component server, the pre-request reply result including a first reply result or a second reply result, the first reply result being used for indicating that the article transfer pre-request fails validity verification, and the second reply result being used for indicating that the article transfer pre-request passes validity verification; and
the third acquiring subunit 1334 is configured to: perform asset transfer processing on the to-be-transferred asset corresponding to the asset value when the pre-request reply result is the second reply result, and acquiring the asset transfer credential for the target article according to the asset transfer processing result.

The apparatus further includes: a second generation subunit 1333, configured to generate a pre-request failure prompt for the target article when the pre-request reply result is the first reply result.

For specific function implementations of the second sending subunit 1331, the second acquiring subunit 1332, the second generation subunit 1333, and the third acquiring subunit 1334, refer to step S103 in the foregoing embodiment corresponding to FIG. 3.

Referring to FIG. 18 again, the third acquiring subunit 1334 may include: a first processing subunit 13341, a second processing subunit 13342, a first transmission subunit 13343, a second transmission subunit 13344, a third transmission subunit 13345, and a fourth transmission subunit 13346.

The first processing subunit 13341 is configured to perform asset transfer processing on the to-be-transferred asset corresponding to the asset value by using the universal transaction component, to obtain the asset transfer processing result, the asset transfer processing result including a first processing result or a second processing result, the first processing result being used for representing that asset transfer processing of the to-be-transferred asset succeeds, and the second processing result being used for representing that asset transfer processing of the to-be-transferred asset fails;
the second processing subunit 13342 is further configured to generate an asset transfer notification for the target article when the asset transfer processing result is the first processing result;
the first transmission subunit 13343 is configured to invoke a target transaction interface that is in the universal transaction component and that is corresponding to the target transaction manner, and transmit the asset transfer notification to an original transaction component corresponding to the target transaction manner;
the second transmission subunit 13344 is configured to send the asset transfer notification to the target transaction server by using the original transaction component, so that the target transaction server performs a verification operation on the asset transfer notification to obtain a verification result, the verification result including a first verification result or a second verification result, the first verification result being used for representing that the target transaction server acknowledges the asset transfer notification, and the second verification result being used for representing that the target transaction server rejects the asset transfer notification;
the third transmission subunit 13345 is further configured to acquire, by using the original transaction component, the asset transfer credential returned by the target transaction server when the verification result is the first verification result; and
the fourth transmission subunit 13346 is configured to return the asset transfer credential to the universal transaction component by using the target transaction interface.

The apparatus further includes:
a second processing subunit 13342, configured to generate an asset transfer failure prompt for the to-be-transferred asset when the asset transfer processing result is the second processing result; and
a third transmission subunit 13345, configured to acquire, by using the original transaction component, an asset transfer failure notification returned by the target transaction server when the verification result is the second verification result.

For specific function implementations of the first processing subunit 13341, the second processing subunit 13342, the first transmission subunit 13343, the second transmission subunit 13344, the third transmission subunit 13345, and the fourth transmission subunit 13346, refer to step S103 in the embodiment corresponding to FIG. 3.

Referring to FIG. 18 again, the first sending module 14 may include: a fourth generation unit 141, a third sending unit 142, and a third acquiring unit 143.

The fourth generation unit 141 is configured to generate a credential verification request including the asset transfer credential;
the third sending unit 142 is configured to send the credential verification request to the universal component server by using the universal transaction component, so that the universal component server returns the credential verification result, the credential verification result being obtained by the universal component server and a target transaction server by performing validity verification on the asset transfer credential; and
the third acquiring unit 143 is configured to the credential verification result by using the universal transaction component.

For specific function implementations of the fourth generation unit 141, the third sending unit 142, and the third acquiring unit 143, refer to step S104 in the embodiment corresponding to FIG. 3.

Referring to FIG. 18 again, the credential verification result includes a verification success result or a verification failure result, the verification success result is used for representing that the asset transfer credential passes validity verification by the target transaction server, and the verification failure result is used for representing that the asset transfer credential fails validity verification by the target transaction server;

The second sending module 15 may include: a fifth generation unit 151, a fourth sending unit 152, and a fourth acquiring unit 153.

The fifth generation unit 151 is further configured to generate the article transfer request for the target article when the credential verification result is the verification success result;
the fourth sending unit 152 is configured to send the article transfer request to the universal component server by using the universal transaction component, so that the universal component server returns the article transfer feedback information, the article transfer feedback information being obtained by verifying the article transfer request by the universal component server, a public server, and a target application server, and the target application server referring to a background server corresponding to the target application client; and
the fourth acquiring unit 153 is configured to acquire the article transfer feedback information by using the universal transaction component.

The apparatus further includes:

a fifth generation unit 151, configured to generate a credential verification failure prompt when the credential verification result is the verification failure result.

For specific function implementations of the fifth generation unit 151, the fourth sending unit 152, and the fourth acquiring unit 153, refer to step S105 in the embodiment corresponding to FIG. 3.

In the embodiments of this application, the universal transaction component is integrated with a universal transaction function corresponding to multiple transaction manners. Therefore, by integrating the universal transaction component into the target application client, not only the article in the target application client can be purchased by a user in multiple payment manners (that is, the foregoing M transaction manners), but also access efficiency of the application developer integrating multiple payment manners into the target application client can be improved. In addition, in the embodiments of this application, both the asset transfer credential and the credential verification result can be sent to the universal component server by using the universal transaction component, so that the universal component server performs a corresponding operation and returns a result (including the foregoing credential verification result and article transfer feedback information). In a user payment process, verification processing on a transaction request that is only concentrated on the target application server (a background server corresponding to the target application client) can be avoided, and payment efficiency and accuracy of the user can be improved.

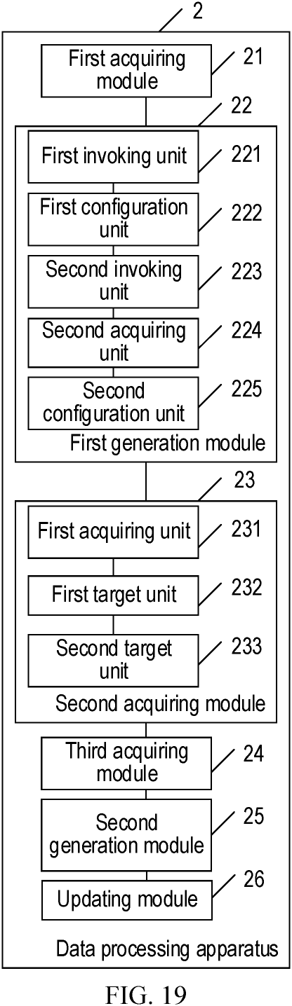

Further, referring to FIG. 19, FIG. 19 is a schematic structural diagram of a data processing apparatus according to an embodiment of this disclosure. The foregoing data processing apparatus may be a computer program (including program code) running in a computer device. For example, the data processing apparatus is application software. The apparatus may be configured to perform corresponding steps in the method provided in the embodiment of this disclosure. As shown in FIG. 19, the data processing apparatus 2 may include: a first acquiring module 21, a first generation module 22, and a second acquiring module 23. For another example, the data processing apparatus is implemented in hardware. The first acquiring module 21 is electrically connected to the first generation module 22 (e.g., the output of the module 21 is fed to the input of the module 22), the first generation module 22 is electrically connected to the second acquiring module 23 (e.g., the output of the module 22 is fed to the input of the module 23). Electrical connection (the solid lines in the figures) may refer to connection via circuitry within a processor or communication bus, or wireless connection. The same understanding also applies to the submodules and subunits within the modules, as well as FIG. 18 and other similar figures. Electrical connection may also be based on the communication connection described in this disclosure.

The first acquiring module 21 is configured to acquire an article configuration request for a target application client, the target application client being integrated with a universal transaction component, the universal transaction component being integrated with a universal transaction function corresponding to M transaction manners, M being a positive integer, the M transaction manners including a target transaction manner, and an article in the target application client including a target article;
the first generation module 22 is configured to invoke an article configuration component according to the article configuration request, and configure the article in the target application client by using the article configuration component, to generate article configuration information, the article configuration component being provided by a universal component server, the universal component server being a server associated with the universal transaction component, and the article configuration information including first article data corresponding to the target article; and
the second acquiring module 23 is configured to acquire a configuration pull request that is sent by a user terminal and that is for the target application client, and send the article configuration information to the user terminal according to the configuration pull request, so that the user terminal invokes the universal transaction component in a case of obtaining a transaction request for the target article, and performs article transaction processing on the target article according to the first article data and the target transaction manner carried in the transaction request, the user terminal referring to a terminal on which the target application client is installed.

For specific function implementations of the first acquiring module 21, the first generation module 22, and the second acquiring module 23, refer to step S201 to step S203 in the embodiment corresponding to FIG. 12.

Referring to FIG. 19 again, the first generation module 22 may include: a first invoking unit 221 and a first configuration unit 222.

The first invoking unit 221 is configured to invoke the article configuration component according to the article configuration request, the article configuration component being integrated with a universal configuration function corresponding to W configuration manners, W being a positive integer, and the W configuration manners including a configuration region manner; and

the first configuration unit 222 is configured to acquire a region transaction manner corresponding to a configuration region from the M transaction manners in response to a trigger operation on the configuration region manner, and configure the article in the target application client according to an association relationship between the configuration region and the region transaction manner, to generate the article configuration information.

The second acquiring module 23 may include: a first acquiring unit 231, a first target unit 232, and a second target unit 233.

The first acquiring unit 231 is configured to acquire, according to the configuration pull request, a terminal region to which a network address of the user terminal belongs;
the first target unit 232 is configured to determine a target region transaction manner corresponding to the terminal region according to the association relationship between the configuration region and the region transaction manner; and
the second target unit 233 is configured to send the article configuration information that carries the target region transaction manner to the user terminal.

For specific function implementations of the first invoking unit 221, the first configuration unit 222, the first acquiring unit 231, the first target unit 232, and the second target unit 233, refer to step S202 and step S203 in the foregoing embodiment corresponding to FIG. 12.

Referring to FIG. 19 again, the first generation module 22 may include: a second invoking unit 223, a second acquiring unit 224, and a second configuration unit 225.

The second invoking unit 223 is configured to invoke the article configuration component according to the article configuration request, the article configuration component being integrated with a universal configuration function corresponding to W configuration manners, W being a positive integer, and the W configuration manners including a configuration transaction manner;
the second acquiring unit 224 is configured to acquire a to-be-configured article from the article in the target application client in response to a trigger operation on the configuration transaction manner; and
the second configuration unit 225 is configured to configure, when a recommended transaction manner that is for the to-be-configured article and that is sent by the universal component server is obtained, the to-be-configured article according to the recommended transaction manner to generate the article configuration information.

For specific function implementations of the second invoking unit 223, the second acquiring unit 224, and the second configuration unit 225, refer to step S202 in the embodiment corresponding to FIG. 12.

Referring to FIG. 19 again, the data processing apparatus 2 may further include: a third acquiring module 24, a second generation module 25, and an updating module 26.

The third acquiring module 24 is configured to acquire a transaction reporting record for the target article sent by a user terminal in a user terminal cluster, the target application client being installed on the user terminal in the user terminal cluster, and the transaction reporting record including an asset transfer value for the target article and a transaction manner for the target article;
the second generation module 25 is configured to create a cross-reference test experiment according to the asset transfer value and the transaction manner, and execute the cross-reference test experiment to obtain a test experiment result, the test experiment result including a recommended asset value for the target article and a recommended transaction manner for the target article; and
the updating module 26 is configured to update target article configuration information of the target article according to the recommended asset value and the recommended transaction manner in response to a next article configuration request.

For specific function implementations of the third acquiring module 24 and the second generation module 25, refer to step S203 in the foregoing embodiment corresponding to FIG. 12.

It can be learned from the foregoing that, by integrating the universal transaction component into the target application client, not only the article in the target application client can be purchased by a user in multiple payment manners (that is, the foregoing M transaction manners), but also access efficiency of the application developer integrating multiple payment manners into the target application client can be improved. In addition, in the embodiments of this application, both the asset transfer credential and the credential verification result can be sent to the universal component server by using the universal transaction component, so that the universal component server performs a corresponding operation and returns a result (including the foregoing credential verification result and article transfer feedback information). In a user payment process, verification processing on a transaction request that is only concentrated on the target application server (a background server corresponding to the target application client) can be avoided, and payment efficiency and accuracy of the user can be improved.

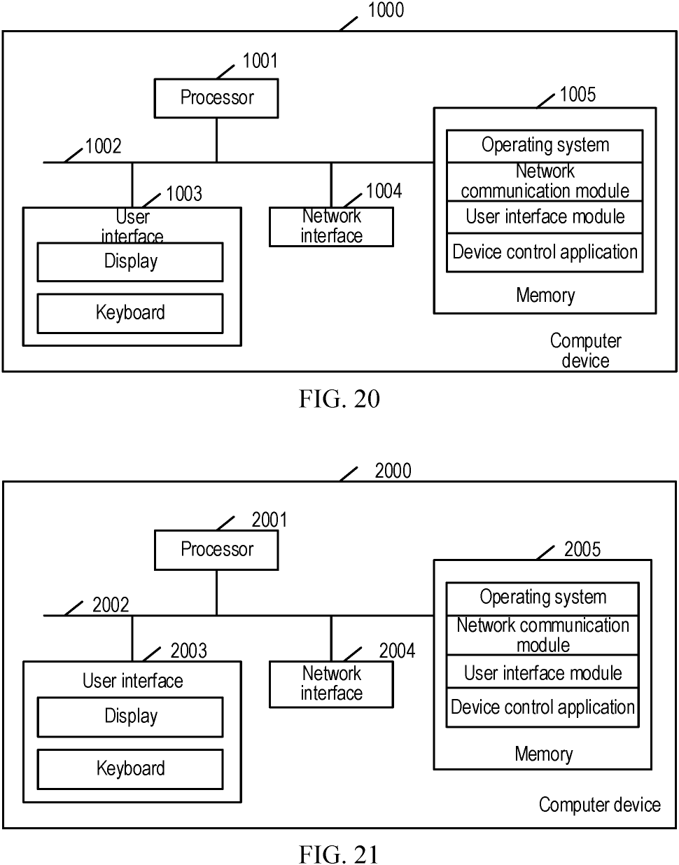

Further, referring to FIG. 20, FIG. 20 is a schematic structural diagram of a computer device according to an embodiment of this disclosure. As shown in FIG. 20, the computer device 1000 may be the user terminal in the foregoing embodiment corresponding to FIG. 3, and the computer device 1000 may include: at least one processor 1001, for example, a CPU, at least one network interface 1004, a user interface 1003, a memory 1005, and at least one communications bus 1002. the communication bus 1002 is configured to implement connection and communication between these components. The user interface 1003 may include a display and a keyboard, and the network interface 1004 may include a standard wired interface and a wireless interface (such as a Wi-Fi interface). The memory 1005 may be a high-speed RAM memory, or may be a non-volatile memory, for example, at least one magnetic disk memory. The memory 1005 may be at least one storage apparatus located remotely from the foregoing processor 1001. As shown in FIG. 20, the memory 1005 used as a computer storage medium may include an operating system, a network communication module, a user interface module, and a device-control application program.

In the computer device 1000 shown in FIG. 20, the network interface 1004 may provide a network communication function. The user interface 1003 is mainly configured to provide an input interface for a user. The processor 1001 may be configured to invoke a device-control application program stored in the memory 1005, so as to implement the data processing method provided in the foregoing embodiment.

It is to be understood that the computer device 1000 described in this embodiment of this disclosure may perform the foregoing description of the data processing method in the embodiments corresponding to FIG. 3, FIG. 11, and FIG. 12, or may perform the foregoing description of the data processing apparatus 1 in the embodiment corresponding to FIG. 18.

Further, referring to FIG. 21, FIG. 21 is a schematic structural diagram of a computer device according to an embodiment of this disclosure. As shown in FIG. 21, the computer device 2000 may be the public server in the foregoing embodiment corresponding to FIG. 12, and the computer device 2000 may include: a processor 2001, a network interface 2004, and a memory 2005. In addition, the foregoing computer device 2000 may further include: a user interface 2003 and at least one communication bus 2002. the communication bus 2002 is configured to implement connection and communication between these components. The user interface 2003 may include a display and a keyboard. The user interface 2003 may further include a standard wired interface and wireless interface. The network interface 2004 may include a standard wired interface and wireless interface (for example, a Wi-Fi interface). The memory 2005 may be a high-speed random access memory (RAM), or may be a non-volatile memory, for example, at least one magnetic disk storage. The memory 2005 may be at least one storage apparatus that is located far away from the foregoing processor 2001. As shown in FIG. 21, the memory 2005 used as a computer readable storage medium may include an operating system, a network communication module, a user interface module, and a device-control application program.

In the computer device 2000 shown in FIG. 21, the network interface 2004 may provide a network communication function. The user interface 2003 is mainly configured to provide an input interface for a user. The processor 2001 may be configured to invoke a device-control application program stored in the memory 2005, so as to implement the data processing method provided in the foregoing embodiment.

It is to be understood that the computer device 2000 described in this embodiment of this disclosure may perform the foregoing description of the data processing method in the embodiments corresponding to FIG. 3, FIG. 11, and FIG. 12, or may perform the foregoing description of the data processing apparatus 2 in the embodiment corresponding to FIG. 19.

An embodiment of this disclosure further provides a computer readable storage medium. The computer readable storage medium stores a computer program. The computer program includes program instructions. When being executed by a processor, the program instructions implement the data processing method provided in steps in FIG. 3, FIG. 11, and FIG. 12. For details, refer to the foregoing implementations provided in steps in FIG. 3, FIG. 11, and FIG. 12.

The foregoing computer readable storage medium may be the data processing apparatus provided in any one of the foregoing embodiments or an internal storage unit of the foregoing computer device, such as a hard disk or a memory of the computer device. The computer readable storage medium may also be an external storage device of the computer device, for example, a plug type hard disk, a smart media card (SMC), a secure digital (SD) card, and a flash card that are configured on the computer device. Further, the computer readable storage medium may further include an internal storage unit of the computer device and an external storage device. The computer readable storage medium is configured to store the computer program and other programs and data required by the computer device. The computer readable storage medium may be further configured to temporarily store data that has been or is to be output.

An embodiment of this disclosure provides a computer program product or a computer program. The computer program product or the computer program includes computer instructions, and the computer instructions are stored in a computer-readable storage medium. A processor of a computer device reads the computer instructions from the computer-readable storage medium, and the processor executes the computer instructions, so that the computer device may perform the foregoing description of the data processing method in the embodiments corresponding to FIG. 3, FIG. 11, and FIG. 12.

What is claimed is:

1. A data processing method performed by a computer device and comprising:
acquiring a transaction request for a target article, and invoking a universal transaction component according to the transaction request, the universal transaction component being integrated with a universal transaction function corresponding to M transaction manners, the universal transaction component being integrated into a target application client, the transaction request carrying an article metric value for the target article and a target transaction manner for the target article, M being a positive integer, and the M transaction manners comprising the target transaction manner;
performing, with the universal transaction component, article metric transfer processing of the article metric value according to first article data of the target article and the target transaction manner, to acquire an article metric transfer credential for the target article;
sending, with the universal transaction component, the article metric transfer credential to a universal component server, whereby the universal component server returns a credential verification result, the universal component server being a server associated with the universal transaction component; and
sending, with the universal transaction component, an article transfer request generated according to the credential verification result to the universal component server, whereby the universal component server returns article transfer feedback information for the target article.

2. The method according to claim 1, wherein: the performing the article metric transfer processing of the article metric value according to first article data of the target article and the target transaction manner comprises:
sending, with the universal transaction component, the transaction request to a target transaction server according to the target transaction manner, whereby the target transaction server returns second article data associated with the target article, the target transaction server being a server having a transaction function for the target transaction manner;
generating an article transfer pre-request for the target article according to the first article data and the second article data;
performing, with the universal transaction component, article metric transfer processing of the article metric value according to the article transfer pre-request; and
acquiring the article metric transfer credential for the target article according to an article metric transfer processing result.

3. The method according to claim 2, wherein the sending the transaction request to the target transaction server according to the target transaction manner comprises:
invoking a target transaction interface that is in the universal transaction component and that is corresponding to the target transaction manner;
transmitting the transaction request to an original transaction component corresponding to the target transaction manner via the target transaction interface;
sending, with the original transaction component, the transaction request to the target transaction server, whereby the target transaction server determines the second article data corresponding to the target article from article data respectively corresponding to P articles, and returns the second article data to the original transaction component, P being a positive integer; and
acquiring, via the target transaction interface, the second article data returned by the original transaction component.

4. The method according to claim 2, wherein the generating the article transfer pre-request for the target article according to the first article data and the second article data comprises:
comparing the first article data with the second article data; and
generating the article transfer pre-request for the target article in response to the first article data being identical with the second article data.

5. The method according to claim 4, wherein the method further comprises:
generating an article error data prompt for the target article in response to the first article data being different from the second article data.

6. The method according to claim 2, wherein the performing the article metric transfer processing of the article metric value according to the article transfer pre-request, and acquiring the article metric transfer credential for the target article comprises:
sending, with the universal transaction component, the article transfer pre-request to the universal component server, whereby the universal component server performs validity verification on the article transfer pre-request, and generates a pre-request reply result according to a validity verification result;
acquiring, with the universal transaction component, the pre-request reply result returned by the universal component server, the pre-request reply result comprising a first reply result or a second reply result, the first reply result being for indicating that the article transfer pre-request fails validity verification, and the second reply result being for indicating that the article transfer pre-request passes validity verification; and
performing article metric transfer processing of the article metric value in response to the pre-request reply result being the second reply result, and acquiring the article metric transfer credential for the target article according to the article metric transfer processing result.

7. The method according to claim 6, wherein the method further comprises:
generating a pre-request failure prompt for the target article in response to the pre-request reply result being the first reply result.

8. The method according to claim 6, wherein the performing article metric transfer processing of the article metric value, and acquiring the article metric transfer credential for the target article comprises:
performing, with the universal transaction component, article metric transfer processing of the article metric value, to obtain the article metric transfer processing result, the article metric transfer processing result comprising a first processing result or a second processing result, the first processing result being for indicating that article metric transfer processing succeeds, and the second processing result being for indicating that article metric transfer processing fails;
generating an article metric transfer notification for the target article in response to the article metric transfer processing result being the first processing result;
invoking a target transaction interface that is in the universal transaction component and that is corresponding to the target transaction manner, and transmitting the article metric transfer notification to an original transaction component corresponding to the target transaction manner;
sending, with the original transaction component, the article metric transfer notification to the target transaction server, whereby the target transaction server performs a verification operation on the article metric transfer notification to obtain a verification result, the verification result comprising a first verification result or a second verification result, the first verification result being for indicating that the target transaction server acknowledges the article metric transfer notification, and the second verification result being for indicating that the target transaction server rejects the article metric transfer notification;
acquiring, with the original transaction component, the article metric transfer credential returned by the target transaction server in response to the verification result being the first verification result; and
returning the article metric transfer credential to the universal transaction component via the target transaction interface.

9. The method according to claim 8, wherein the method further comprises:
generating an article metric transfer failure prompt in response to the article metric transfer processing result being the second processing result; and
acquiring, with the original transaction component, an article metric transfer failure notification returned by the target transaction server in response to the verification result being the second verification result.

10. The method according to claim 1, wherein the sending the article metric transfer credential to a universal component server comprises:
generating a credential verification request comprising the article metric transfer credential;
sending, with the universal transaction component, the credential verification request to the universal component server, whereby the universal component server returns the credential verification result, the credential verification result being obtained by the universal component server and a target transaction server performing validity verification on the article metric transfer credential; and
acquiring, with the universal transaction component, the credential verification result.

11. The method according to claim 1, wherein the credential verification result comprises a verification success result or a verification failure result, the verification success result is for indicating that the article metric transfer credential passes validity verification by a target transaction server, and the verification failure result is for indicating that the article metric transfer credential fails validity verification by the target transaction server; and
the sending the article transfer request generated according to the credential verification result to the universal component server comprises:
generating the article transfer request for the target article in response to the credential verification result being the verification success result;
sending, with the universal transaction component, the article transfer request to the universal component server, whereby the universal component server returns the article transfer feedback information, the article transfer feedback information being obtained by verifying the article transfer request by the universal component server, a public server, and a target application server, and the target application server referring to a background server corresponding to the target application client; and
acquiring, with the universal transaction component, the article transfer feedback information.

12. The method according to claim 11, wherein the method further comprises:
generating a credential verification failure prompt in response to the credential verification result being the verification failure result.

13. The method according to claim 1, wherein the method further comprises:
acquiring article configuration information that is sent by a public server and that is for the target application client, the article configuration information comprising the first article data corresponding to the target article.

14. The method according to claim 13, wherein the acquiring the article configuration information comprises:
sending a configuration pull request to the public server in response to an article configuration operation on the target application client, the public server storing article configuration information, the article configuration information being generated by the public server separately configuring N articles according to an article configuration component provided by the universal component server, the article configuration information comprising target article configuration information for the target article, the target article configuration information comprising the target transaction manner, a target article identifier, and the article metric value of the target article, the N articles comprising the target article, and N being a positive integer; and
acquiring the article configuration information returned by the public server.

15. The method according to claim 14, wherein the acquiring the transaction request for the target article comprises:
generating the transaction request for the target article according to the target article identifier in response to a transaction operation on the target article.

16. A data processing method performed by a computer device and comprising:
acquiring an article configuration request for a target application client, the target application client being integrated with a universal transaction component, the universal transaction component being integrated with a universal transaction function corresponding to M transaction manners, M being a positive integer, the M transaction manners comprising a target transaction manner, and an article in the target application client comprising a target article;
invoking an article configuration component according to the article configuration request, and configuring the article in the target application client using the article configuration component, to generate article configuration information, the article configuration component being provided by a universal component server, the universal component server being a server associated with the universal transaction component, and the article configuration information comprising first article data corresponding to the target article; and
acquiring a configuration pull request that is sent by a user terminal and that is for the target application client, and sending the article configuration information to the user terminal according to the configuration pull request, whereby the user terminal invokes the universal transaction component in response to obtaining a transaction request for the target article, and performs article transaction processing on the target article according to the first article data and the target transaction manner carried in the transaction request, the user terminal referring to a terminal on which the target application client is installed.

17. The method according to claim 16, wherein the invoking the article configuration component according to the article configuration request, and configuring the article in the target application client to generate the article configuration information comprises:
invoking the article configuration component according to the article configuration request, the article configuration component being integrated with a universal configuration function corresponding to W configuration manners, W being a positive integer, and the W configuration manners comprising a configuration region manner; and
acquiring a region transaction manner corresponding to a configuration region from the M transaction manners in response to a trigger operation on the configuration region manner, and configuring the article in the target application client according to an association relationship between the configuration region and the region transaction manner, to generate the article configuration information; and
the sending the article configuration information to the user terminal according to the configuration pull request comprises:
acquiring, according to the configuration pull request, a terminal region to which a network address of the user terminal belongs;
determining a target region transaction manner corresponding to the terminal region according to the association relationship between the configuration region and the region transaction manner; and
sending the article configuration information carrying the target region transaction manner to the user terminal.

18. The method according to claim 16, wherein the invoking an article configuration component according to the article configuration request, and configuring the article in the target application client to generate the article configuration information comprises:
invoking the article configuration component according to the article configuration request, the article configuration component being integrated with a universal configuration function corresponding to W configuration manners, W being a positive integer, and the W configuration manners comprising a configuration transaction manner;
acquiring an article to be configured from articles in the target application client in response to a trigger operation on the configuration transaction manner; and
configuring, in response to obtaining a recommended transaction manner that is for the article to be configured and that is sent by the universal component server, the article to be configured according to the recommended transaction manner to generate the article configuration information.

19. The method according to claim 16, wherein the method further comprises:
acquiring a transaction reporting record sent by a user terminal in a user terminal cluster, the target application client being installed on the user terminal in the user terminal cluster, and the transaction reporting record comprising an article metric transfer value for the target article and a transaction manner for the target article;
creating a cross-reference test experiment according to the article metric transfer value and the transaction manner, and performing the cross-reference test experiment to obtain a test experiment result, the test experiment result comprising a recommended article metric value for the target article and a recommended transaction manner for the target article; and
updating target article configuration information of the target article according to the recommended article metric value and the recommended transaction manner in response to a next article configuration request.

20. A data processing apparatus, comprising:
a memory operable to store computer-readable instructions; and
a processor circuitry operable to read the computer-readable instructions, the processor circuitry when executing the computer-readable instructions is configured to:
acquire a transaction request for a target article, and invoke a universal transaction component according to the transaction request, the universal transaction component being integrated with a universal transaction function corresponding to M transaction manners, the universal transaction component being integrated into a target application client, the transaction request carrying an article metric value for the target article and a target transaction manner for the target article, M being a positive integer, and the M transaction manners comprising the target transaction manner;
perform, with the universal transaction component, article metric transfer processing of the article metric value according to first article data of the target article and the target transaction manner, to acquire an article metric transfer credential for the target article;
send, with the universal transaction component, the article metric transfer credential to a universal component server, whereby the universal component server returns a credential verification result, the universal component server being a server associated with the universal transaction component; and
send, with the universal transaction component, an article transfer request generated according to the credential verification result to the universal component server, whereby the universal component server returns article transfer feedback information for the target article.
